(19) United States
(12) Patent Application Publication
(10) Pub. No.: US 2026/0029619 A1
(43) Pub. Date: Jan. 29, 2026

(54) CAMERA LENS ASSEMBLY

(71) Applicant: Zhejiang Sunny Optics Co., Ltd., Yuyao City (CN)

(72) Inventors: Huan LI, Yuyao City (CN); Jiayu CAI, Yuyao City (CN); Fang ZHANG, Yuyao City (CN); Saifeng LYU, Yuyao City (CN); Peng GAO, Yuyao City (CN); Liefeng ZHAO, Yuyao City (CN)

(21) Appl. No.: 18/983,663

(22) Filed: Dec. 17, 2024

(30) Foreign Application Priority Data
Jul. 25, 2024 (CN) 202411008684.X

(51) Int. Cl. G02B 13/00; G02B 9/62; G02B 27/00

(52) U.S. Cl. CPC G02B 13/0045; G02B 9/62; G02B 27/0018

(57) ABSTRACT

The present disclosure discloses a camera lens assembly, which includes an optical lens group, a spacing element group and a lens barrel. The optical lens group includes a first lens, a second lens, a third lens, a fourth lens, a fifth lens, and a sixth lens. The spacing element group includes a second spacing element, a third spacing element, and a fourth spacing element; an inner diameter d0m of an image-side end surface of the lens barrel and half of a maximal field-of-view Semi-FOV of the camera lens assembly satisfy: 4.2 mm<d0m/tan(Semi-FOV)<5.0 mm; and a spacing distance EP23 between the second spacing element and the third spacing element in a direction of the optical axis, an air gap T23 between the second lens and the third lens on the optical axis, and an air gap T34 between the third lens and the fourth lens on the optical axis satisfy:

$$0.9 < EP 23 / ( T 23 + T 34 ) < 1.8 .$$

### CROSS-REFERENCE TO RELATED APPLICATIONS

This patent application claims the priority to and benefits of Chinese Patent Application No. 202411008684.X, filed on Jul. 25, 2024 and entitled “Camera Lens Assembly,” the disclosure of which is incorporated herein by reference in its entirety.

### TECHNICAL FIELD

The present disclosure relates to the field of optical device, and in particular to a camera lens assembly.

### BACKGROUND

With the rapid development of modern photography and videography technologies, camera lens assemblies have received widespread attention and been widely applied due to their ability to acquire a wider field-of-view. Camera lens assemblies have realized a large field-of-view to a certain extent, however, with an increase in the size and weight of the lens assemblies, the design of large head and large base makes the lens assemblies less flexible during installation and use. In some scenarios with demanding space requirements, such as drone aerial photography equipment, small photography equipment, or front-facing cameras on smartphones, the application of camera lens assemblies is greatly restricted.

### SUMMARY

The present disclosure provides such a camera lens assembly, and the camera lens assembly includes an optical lens group, a spacing element group and a lens barrel. The optical lens group includes, sequentially along an optical axis from an object side to an image side: a first lens, a second lens, a third lens, a fourth lens, a fifth lens, and a sixth lens that have refractive powers. A refractive index of the third lens is greater than a refractive index of the second lens and a refractive index of the fourth lens, a refractive index of the fourth lens is less than a refractive index of the third lens and a refractive index of the fifth lens, and each of an object-side surface of the fifth lens and an image-side surface of the fifth lens has at least one inflection point; the spacing element group includes a second spacing element, a third spacing element, and a fourth spacing element, where the second spacing element is disposed on an image-side surface of the second lens and is in contact with the image-side surface of the second lens, the third spacing element is disposed on an image-side surface of the third lens and is in contact with the image-side surface of the third lens, and the fourth spacing element is disposed on an image-side surface of the fourth lens and is in contact with the image-side surface of the fourth lens; the lens barrel accommodates the optical lens group and the spacing element group; where, an inner diameter d0m of an image-side end surface of the lens barrel and half of a maximal field-of-view Semi-FOV of the camera lens assembly satisfy: 4.2 mm<d0m/tan(Semi-FOV)<5.0 mm; a spacing distance EP23 between the second spacing element and the third spacing element in a direction of the optical axis, an air gap T23 between the second lens and the third lens on the optical axis, and an air gap T34 between the third lens and the fourth lens on the optical axis satisfy: 0.9<EP23/(T23+T34)<1.8; and a spacing distance EP34 between the third spacing element and the fourth spacing element in the direction of the optical axis, the air gap T34 between the third lens and the fourth lens on the optical axis, and an air gap T45 between the fourth lens and the fifth lens on the optical axis satisfy:

$$0.8 < EP 34 / ( T 34 + T 45 ) < 2.5 .$$

According to an exemplary implementation of the present disclosure, an outer diameter D0m of the image-side end surface of the lens barrel, an outer diameter D0s of an object-side end surface of the lens barrel, and half of the maximal field-of-view Semi-FOV of the camera lens assembly satisfy: 85.1°<(D0m/D0s)*Semi-FOV<90.6°.

According to an exemplary implementation of the present disclosure, the spacing distance EP34 between the third spacing element and the fourth spacing element in the direction of the optical axis, a maximal thickness CP4 of the fourth spacing element, and a center thickness CT4 of the fourth lens satisfy:

$$0.7 < ( EP 34 + CP 4 ) / CT 4 < 1 . {2}_{o}$$

According to an exemplary implementation of the present disclosure, an effective focal length f4 of the fourth lens, a distance SAG42 from an intersection point of the image-side surface of the fourth lens on the optical axis to a vertex of an effective radius of the image-side surface of the fourth lens on the optical axis, and the spacing distance EP34 between the third spacing element and the fourth spacing element in the direction of the optical axis satisfy: 1.8<f4/(|SAG42|+EP34)<3.2.

According to an exemplary implementation of the present disclosure, a distance SAG31 from an intersection point of an object-side surface of the third lens on the optical axis to a vertex of an effective radius of the object-side surface of the third lens on the optical axis, a center thickness CT3 of the third lens, and the spacing distance EP23 between the second spacing element and the third spacing element in the direction of the optical axis satisfy: 0.9<(|SAG31|+CT3)/EP23<1.50.

According to an exemplary implementation of the present disclosure, an inner diameter d3s of an object-side surface of the third spacing element, an inner diameter d2s of an object-side surface of the second spacing element, and a refractive index N3 of the third lens satisfy: 1.8<d3s/d2s*N3<2.2.

According to an exemplary implementation of the present disclosure, an inner diameter d4s of an object-side surface of the fourth spacing element, an inner diameter d3s of an object-side surface of the third spacing element, and a refractive index N4 of the fourth lens satisfy: 1.7<d4s/d3s*N4<2.5.

According to an exemplary implementation of the present disclosure, an effective focal length f1 of the first lens and an effective focal length f5 of the fifth lens satisfy: −4.2<f1/f5<−2.1; an effective focal length f3 of the third lens and an effective focal length f of the camera lens assembly satisfy: −5.8<f3/f<−2.2; an effective focal length f2 of the second lens and an effective focal length f4 of the fourth lens satisfy:

$$1.6 < f 2 / f 4 < 2 . {4}_{o}$$

According to an exemplary implementation of the present disclosure, an inner diameter d0s of an object-side end surface of the lens barrel and an effective focal length f of the camera lens assembly satisfy: 0.9<d0s/f<1.3.

According to an exemplary implementation of the present disclosure, an outer diameter D4s of an object-side surface of the fourth spacing element, an effective radius DT42 of the image-side surface of the fourth lens, and an inner diameter d4s of the object-side surface of the fourth spacing element satisfy: 0.9<(D4s−DT42)/d4s<1.7.

According to an exemplary implementation of the present disclosure, the effective focal length f2 of the second lens, the effective focal length f3 of the third lens, the inner diameter d2s of the object-side surface of the second spacing element, and the inner diameter d3s of the object-side surface of the third spacing element satisfy: −

$$2.8 < f 3 / f 2 / ( d 3 s / d 2 s ) < - 1.4 .$$

According to an exemplary implementation of the present disclosure, the spacing element group further includes a fifth spacing element disposed on the image-side surface of the fifth lens and at least partially in contact with the image-side surface of the fifth lens; and an outer diameter D4m of an image-side surface of the fourth spacing element, an outer diameter D5m of an image-side surface of the fifth spacing element, and a spacing distance EP45 between the fourth spacing element and the fifth spacing element in the direction of the optical axis satisfy:

$$18.4 < ( D 4 m + D 5 m ) / EP 45 < 26.2 .$$

According to an exemplary implementation of the present disclosure, a radius of curvature R7 of an object-side surface of the fourth lens, a radius of curvature R8 of the image-side surface of the fourth lens, a radius of curvature R3 of an object-side surface of the second lens, and a radius of curvature R4 of the image-side surface of the second lens satisfy: −1.1<(R7+R8)/(R3−R4)<−0.5; and the outer diameter D4m of the image-side surface of the fourth spacing element and an outer diameter D2s of the object-side surface of the second spacing element satisfy: 1.0<D4m/D2s<1.9.

According to an exemplary implementation of the present disclosure, the spacing element group further includes a sixth spacing element disposed on an image-side surface of the sixth lens and at least partially in contact with the image-side surface of the sixth lens, an object-side surface of the sixth lens has at least one inflection point; and a distance YC52 from an inflection point nearest to the optical axis on the image-side surface of the fifth lens to the optical axis, a distance YC61 from an inflection point nearest to the optical axis on the object-side surface of the sixth lens to the optical axis, and a spacing distance EP46 between the fourth spacing element and the sixth spacing element in the direction of the optical axis satisfy: 1.4<(YC52+YC61)/EP46<2.2.

### BRIEF DESCRIPTION OF THE DRAWINGS

By reading detailed descriptions of non-limiting embodiments given with reference to the following accompanying drawings, other features, objectives and advantages of the present disclosure will become more apparent. In which:

FIG. 1 illustrates a component and parameter labelling diagram of a camera lens assembly according to the present disclosure;

FIG. 2 illustrates a parameter labelling diagram of an optical lens group of the camera lens assembly according to the present disclosure;

FIG. 3 illustrates a schematic structural diagram of a camera lens assembly according to Embodiment 1 of the present disclosure;

FIG. 4 illustrates a schematic structural diagram of a camera lens assembly according to Embodiment 2 of the present disclosure;

FIG. 5A to FIG. 5D respectively illustrate a longitudinal aberration curve, an astigmatic curve, a distortion curve and a lateral color curve of the camera lens assembly according to Embodiment 1 or Embodiment 2 of the present disclosure;

FIG. 6 illustrates a schematic structural diagram of a camera lens assembly according to Embodiment 3 of the present disclosure;

FIG. 7 illustrates a schematic structural diagram of a camera lens assembly according to Embodiment 4 of the present disclosure;

FIG. 8A to FIG. 8D respectively illustrate a longitudinal aberration curve, an astigmatic curve, a distortion curve and a lateral color curve of the camera lens assembly according to Embodiment 3 or Embodiment 4 of the present disclosure;

FIG. 9 illustrates a schematic structural diagram of a camera lens assembly according to Embodiment 5 of the present disclosure;

FIG. 10 illustrates a schematic structural diagram of a camera lens assembly according to Embodiment 6 of the present disclosure;

FIG. 11A to FIG. 11D respectively illustrate a longitudinal aberration curve, an astigmatic curve, a distortion curve and a lateral color curve of the camera lens assembly according to Embodiment 5 or Embodiment 6 of the present disclosure;

FIG. 12 illustrates a schematic structural diagram of a camera lens assembly according to Embodiment 7 of the present disclosure;

FIG. 13 illustrates a schematic structural diagram of a camera lens assembly according to Embodiment 8 of the present disclosure; and

FIG. 14A to FIG. 14D respectively illustrate a longitudinal aberration curve, an astigmatic curve, a distortion curve and a lateral color curve of the camera lens assembly according to Embodiment 7 or Embodiment 8 of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements.

It should be noted that, in the specification, the expressions such as “first,” “second” and “third” are only used to distinguish one feature from another, rather than represent any limitations to the features. Thus, without departing from the teachings of the present disclosure, the first lens discussed below may also be referred to as the second lens or the third lens.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. A surface of each lens that is closest to a photographed object is referred to as the object-side surface of the lens, and a surface of each lens that is closest to an image plane is referred to as the image-side surface of the lens.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The present disclosure will be described below in detail with reference to the accompanying drawings and in combination with the embodiments.

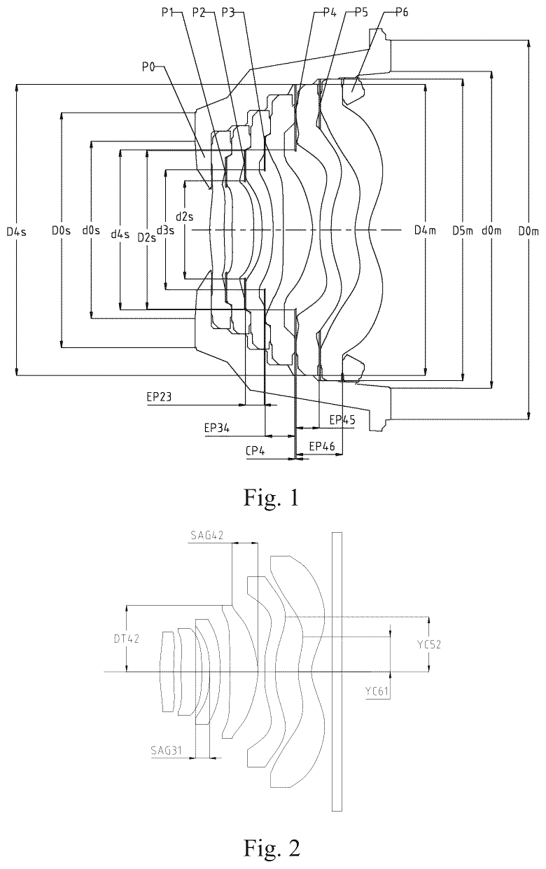

With reference to FIGS. 1-3, FIG. 4, FIG. 6, FIG. 7, FIG. 9, FIG. 10, FIG. 12 and FIG. 13, an aspect of the present disclosure provides such a camera lens assembly, the camera lens assembly may include an optical lens group, the optical lens group may sequentially include a first lens, a second lens, a third lens, a fourth lens, a fifth lens, and a sixth lens along an optical axis from an object side to an image side. The first lens, the second lens, the third lens, the fourth lens, the fifth lens, and the sixth lens all have refractive powers.

In exemplary implementations, there may be a spacing distance between two adjacent lenses from the first lens to the sixth lens, for example, there is an air spacing between two adjacent lenses.

In exemplary implementations, an object-side surface and an image-side surface of the fifth lens each has at least one inflection point, which is conducive to achieving a small head of the camera lens assembly, while maintaining a wide angle of the camera lens assembly.

In exemplary implementations, an object-side surface of the sixth lens has at least one inflection point, which is conducive to achieving a small head of the camera lens assembly, while maintaining a wide angle of the camera lens assembly.

The camera lens assembly may include a spacing element group, and the spacing element group may include at least one of a first spacing element, a second spacing element, a third spacing element, a fourth spacing element, or a fifth spacing element. Here, the first spacing element is disposed between an image-side surface of the first lens and the second lens and is in contact with the image-side surface of the first lens, e.g., the first spacing element is at least partially in contact with the image-side surface of the first lens. The second spacing element is disposed between an image-side surface of the second lens and the third lens and is in contact with the image-side surface of the second lens, e.g., the second spacing element is at least partially in contact with the image-side surface of the second lens. The third spacing element is disposed between an image-side surface of the third lens and the fourth lens and is in contact with the image-side surface of the third lens, e.g., the third spacing element is at least partially in contact with the image-side surface of the third lens. The fourth spacing element is disposed between an image-side surface of the fourth lens and the fifth lens and is in contact with the image-side surface of the fourth lens, e.g., the fourth spacing element is at least partially in contact with the image-side surface of the fourth lens. The fifth spacing element is disposed between the image-side surface of the fifth lens and the sixth lens and is in contact with the image-side surface of the fifth lens, e.g., the fifth spacing element is at least partially in contact with the image-side surface of the fifth lens. Reasonably using the spacing elements can effectively avoid the risk of stray light, reduce interference to an image quality, thus improving an imaging quality of the camera lens assembly, while ensuring support stability of the lenses.

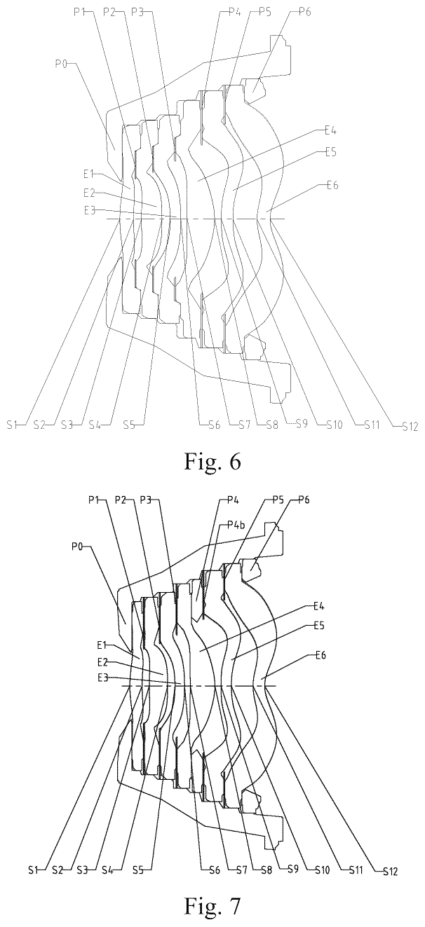

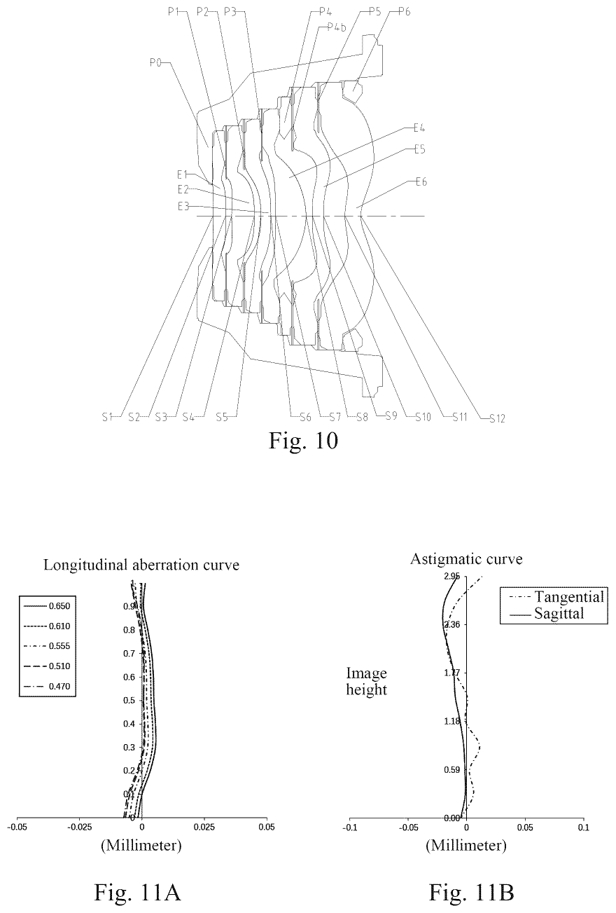

Referring to FIG. 4, FIG. 7, and FIG. 10, the spacing element group may further include a fourth auxiliary spacing element, and the fourth auxiliary spacing element is disposed on an image-side surface of the fourth spacing element and is in contact with the image-side surface of the fourth spacing element, e.g., the fourth auxiliary spacing element is at least partially in contact with the image-side surface of the fourth spacing element.

The camera lens assembly may include a lens barrel, and the lens barrel accommodates the optical lens group and the spacing element group.

In exemplary implementations, the camera lens assembly further includes a diaphragm, and the diaphragm is disposed on an object side of an object-side surface of the first lens.

In exemplary implementations, a refractive index of the third lens is greater than a refractive index of an adjacent lens, that is, the refractive index of the third lens is greater than the refractive index of the fourth lens and the refractive index of the second lens; and the refractive index of the fourth lens is less than the refractive index of an adjacent lens, that is, the refractive index of the fourth lens is less than the refractive index of the third lens and the refractive index of the fifth lens. The arrangement of high and low refractive indices of the lenses is conducive to achieving a large wide-angle of the camera lens assembly, especially the arrangement of high and low refractive indices of the third lens and the fourth lens located in the middle of the lens assembly, which affects the stability of performance after assembly. For the wide-angle lens assembly, a combination of four lenses made of low refractive index material and two lenses made of high refractive index material is designed to realize a wide-angle lens assembly featuring a small head and a small base, and a field-of-view capable of exceeding 101 degrees.

In exemplary implementations, an inner diameter d0m of an image-side end surface of the lens barrel and half of a maximal field-of-view Semi-FOV of the camera lens assembly satisfy: 4.2 mm<d0m/tan(Semi-FOV)<5.0 mm. By controlling the ratio of the inner diameter of the image-side end surface of the lens barrel to a tangent value of half of the maximal field-of-view of the camera lens assembly, it is conducive to achieving a small head of the camera lens assembly, while maintaining a wide angle of the camera lens assembly.

In exemplary implementations, a range of half of the maximal field-of-view Semi-FOV of the camera lens assembly, is controlled to be greater than 50° and less than 55°.

In exemplary implementations, a spacing distance EP23 between the second spacing element and the third spacing element in a direction of the optical axis, an air gap T23 between the second lens and the third lens on the optical axis, and an air gap T34 between the third lens and the fourth lens on the optical axis satisfy: 0.9<EP23/(T23+T34)<1.8; by controlling the sum of the spacing distance between the second lens and the third lens on the optical axis and the spacing distance between the third lens and the fourth lens on the optical axis, and the ratio of this sum to the spacing distance between the second spacing element and the third spacing element in the direction of the optical axis, and controlling the uniformity of edge and center-related sizes of the third lens as well as the air gaps preceding and succeeding the third lens, it is conducive to reducing the sensitivity of assembly tilt of the third lens, and to improving the stability of assembly performance of the third lens.

In exemplary implementations, a spacing distance EP34 between the third spacing element and the fourth spacing element in the direction of the optical axis, the air gap T34 between the third lens and the fourth lens on the optical axis, and an air gap T45 between the fourth lens and the fifth lens on the optical axis satisfy: 0.8<EP34/(T34+T45)<2.5; by controlling the sum of the spacing distance between the third lens and the fourth lens on the optical axis and the spacing distance between the fourth lens and the fifth lens on the optical axis, and the ratio of this sum to the spacing distance between the third spacing element and the fourth spacing element in the direction of the optical axis, and controlling the uniformity of edge and center-related sizes of the fourth lens as well as the air gaps preceding and succeeding the fourth lens, it is conducive to reducing the sensitivity of assembly tilt of the fourth lens, and to improving the stability of assembly performance of the fourth lens.

The relationship between tilt of the lens and sensitivity is further illustrated below in conjunction with Table 1. Table 1 illustrates the sensitivity of the tilt of the third lens and the fourth lens of three types of camera lens assemblies to a field curvature in a T direction. Here, lens assembly 1 satisfies d0m/tan(Semi-FOV)=4.5, EP23/(T23+T34)=1.01, EP34/(T34+T45)=1.69; lens assembly 2 satisfies d0m/tan(Semi-FOV)=4.5, EP23/(T23+T34)=2.49, EP34/(T34+T45)=3.59; and lens assembly 3 satisfies d0m/tan(Semi-FOV)=4.5, EP23/(T23+T34)=0.62, EP34/(T34+T45)=0.78.

In Table 1, the symbols “+” and “−” in “+3” and “−3” represent a direction of tilt of the lens, in “0.1F”, “0.2F”, “0.3F”, “0.4F”, “0.5F”, “0.6F”, “0.7F”, “0.8F”, “0.9F”, and “1.0F”, “F” represents the field-of-view, and the unit of peak impact data is %.

For lens assembly 1, in a field-of-view from 0.1F to 1.0F, when a tilt angle of the third lens deviates by +3′ from a design value, the impact of the tilted third lens on a peak MTF field-of-view ranges from 0.28% to 1.68%, and the data is stable and all positive; in the field-of-view from 0.1F to 1.0F, when the tilt angle of the third lens deviates by −3′ from the design value, the impact of the tilted third lens on the peak MTF field-of-view ranges from 0.1% to −1.75%, and the data is stable; in the field-of-view from 0.1F to 1.0F, when the tilt angle of the fourth lens deviates by +3′ from the design value, the impact of the tilted fourth lens on the peak MTF field-of-view ranges from 0.47% to −5.45%, where, in a field-of-view from 0.1F to 0.7F, the impact of the tilted fourth lens on the peak MTF field-of-view ranges from −0.47% to −2.16%, and the data is stable, in a field-of-view from 0.8F to 1.0F, the impact of the tilted fourth lens on the peak MTF field-of-view ranges from −4.59% to −5.45%; and in the field-of-view from 0.1F to 1.0F, when the tilt angle of the fourth lens deviates by −3′ from the design value, the impact of the tilted fourth lens on the peak MTF field-of-view ranges from 0.53% to 5.77%, and the data is all positive.

For lens assembly 2, in the field-of-view from 0.1F to 1.0F, when the tilt angle of the third lens deviates by +3′ from the design value, the impact of the tilted third lens on the peak MTF field-of-view ranges from −0.73% to 1.19%, and some of the data is positive; in the field-of-view from 0.1F to 1.0F, when the tilt angle of the third lens deviates by −3′ from the design value, the impact of the tilted third lens on the peak MTF field-of-view ranges from −21.67% to 14.23%, and the data varies significantly; in the field-of-view from 0.1F to 1.0F, when the tilt angle of the fourth lens deviates by +3′ from the design value, the impact of the tilted fourth lens on the peak MTF field-of-view ranges from −17.33% to 14.12%, and the data varies significantly; and in the field-of-view from 0.1F to 1.0F, when the tilt angle of the fourth lens deviates by −3′ from the design value, the impact of the tilted fourth lens on the peak MTF field-of-view ranges from −20.00% to 6.00%, and the data varies significantly.

For lens assembly 3, in the field-of-view from 0.1F to 1.0F, when the tilt angle of the third lens deviates by +3′ from the design value, the impact of the tilted third lens on the peak MTF field-of-view ranges from −10.00% to 1.07%, and the data varies significantly; in the field-of-view from 0.1F to 1.0F, when the tilt angle of the third lens deviates by −3′ from the design value, the impact of the tilted third lens on the peak MTF field-of-view ranges from −7.00% to 0%, and the data is all positive; in the field-of-view from 0.1F to 1.0F, when the tilt angle of the fourth lens deviates by +3′ from the design value, the impact of the tilted fourth lens on the peak MTF field-of-view ranges from −5.00% to 73.50%, and the data varies significantly; and in the field-of-view from 0.1F to 1.0F, when the tilt angle of the fourth lens deviates by −3′ from the design value, the impact of the tilted fourth lens on the peak MTF field-of-view ranges from −10.77% to 3.61%, and the data varies over a wide range and is partly negative.

Compared to lens assembly 2 and lens assembly 3, the sensitivity data of the tilted third lens and fourth lens to the peak MTF field-of-view of lens assembly 1 is stable, and adjusting the field-of-view has a minor impact on the peak sensitivity. It can be seen that when the camera lens assembly satisfies “4.2 mm<d0m/tan(Semi-FOV)<5.0 mm”, “0.9<EP23/(T23+T34)<1.8” and “0.8<EP34/(T34+T45)<2.6”, the tilted third lens and fourth lens of lens assembly 1 have minor impact on the sensitivity data of the peak MTF field-of-view, and the sensitivity data has greater impact on an edge field-of-view.

TABLE 1

| | lens assembly 1 | lens assembly 2 | lens assembly 3 |
|---|---|---|---|
| conditional | d0m/tan(Semi-FOV) = 4.5 | d0m/tan(Semi-FOV) = 4.5 | d0m/tan(Semi-FOV) = 4.5 |
| expression | EP23/(T23 + T34) = 1.01 | EP23/(T23 + T34) = 2.49 | EP23/(T23 + T34) = 0.62 |
| value | EP34/(T34 + T45) = 1.69 | EP34/(T34 + T45) = 3.59 | EP34/(T34 + T45) = 0.78 |

| | lens | | | | | | | | | | | |
|---|---|---|---|---|---|---|---|---|---|---|---|---|
| | third lens | | fourth lens | | third lens | | fourth lens | | third lens | | fourth lens | |
| | tilt angle | | | | | | | | | | | |
| | +3′ | −3′ | +3′ | −3′ | +3′ | −3′ | +3′ | −3′ | +3′ | −3′ | +3′ | −3′ |
| 0.1F | 0.28 | −0.10 | −0.47 | 0.53 | −0.73 | 0.63 | −0.57 | 0.37 | 0.28 | −0.44 | −1.84 | 1.95 |
| 0.2F | 0.49 | −0.21 | −0.94 | 1.01 | 0.43 | −0.21 | −1.95 | 1.51 | 0.04 | −0.29 | −1.58 | 0.29 |
| 0.3F | 1.10 | −0.80 | −1.65 | 1.86 | −0.39 | 14.23 | 14.12 | −0.29 | 0.82 | −1.45 | −1.59 | 1.27 |
| 0.4F | 1.68 | −1.75 | −1.30 | 1.14 | 1.19 | −0.25 | −0.50 | 1.29 | 0.52 | −0.41 | −1.23 | 2.01 |
| 0.5F | 1.55 | −1.58 | −1.60 | 1.57 | 1.00 | 1.00 | −17.33 | 1.00 | 0.83 | 0.00 | 73.50 | 1.14 |
| 0.6F | 1.25 | −1.07 | −1.74 | 2.40 | 0.00 | −21.67 | −1.67 | −20.00 | 0.00 | 0.00 | 0.00 | 1.67 |
| 0.7F | 0.75 | −0.74 | −2.16 | 2.53 | 0.00 | −0.05 | −0.77 | 0.00 | −10.00 | −7.00 | 0.00 | −10.77 |
| 0.8F | 0.86 | −0.90 | −4.59 | 3.87 | 0.95 | −0.16 | 0.12 | 4.74 | 0.00 | 0.00 | −5.00 | 0.00 |
| 0.9F | 0.84 | −0.81 | −5.02 | 5.77 | 0.35 | −0.03 | −0.38 | 0.40 | 1.07 | −0.83 | −3.06 | 3.61 |
| 1.0F | 0.52 | −0.50 | −5.45 | 5.46 | 0.00 | 0.00 | −5.00 | 6.00 | −4.00 | 0.00 | 0.31 | 0.77 |

In exemplary implementations, an outer diameter D0m of the image-side end surface of the lens barrel, an outer diameter D0s of an object-side end surface of the lens barrel, and half of the maximal field-of-view Semi-FOV of the camera lens assembly satisfy: 85.1°<(D0m/D0s)*Semi-FOV<90.6°. By controlling the ratio of the outer diameter of the image-side end surface of the lens barrel to the outer diameter of the object-side end surface of the lens barrel, and the product of this ratio and half of the maximal field-of-view of the camera lens assembly, a range of sizes at the bottom of the lens barrel is controlled, which contributes to miniaturization of the lens assembly.

In exemplary implementations, the spacing distance EP34 between the third spacing element and the fourth spacing element in the direction of the optical axis, a maximal thickness CP4 of the fourth spacing element, and a center thickness CT4 of the fourth lens satisfy: 0.7<(EP34+CP4)/CT4<1.2. By controlling the sum of the spacing distance between the third spacing element and the fourth spacing element in the direction of the optical axis and the maximal thickness of the fourth spacing element, and the ratio of this sum to the center thickness of the fourth lens, the relative uniformity of center and edge assembly thicknesses of the fourth lens is controlled, which is conducive to molding stability of the fourth lens.

In exemplary implementations, an effective focal length f4 of the fourth lens, a distance SAG42 from an intersection point of the image-side surface of the fourth lens on the optical axis to a vertex of an effective radius of the image-side surface of the fourth lens on the optical axis, and the spacing distance EP34 between the third spacing element and the fourth spacing element in the direction of the optical axis satisfy: 1.8<f4/(|SAG42|+EP34)<3.2. By controlling the ratio of the effective focal length of the fourth lens to the sum of relevant sizes of the image-side surface of the fourth lens and the spacing distance between the third spacing element and the fourth spacing element in the direction of the optical axis, a range of light at the edge of the fourth lens can be controlled, to avoid stray light while ensuring optical parameters, thereby ensuring the image quality on an image plane.

In exemplary implementations, a distance SAG31 from an intersection point of an object-side surface of the third lens on the optical axis to a vertex of an effective radius of the object-side surface of the third lens on the optical axis, a center thickness CT3 of the third lens, and the spacing distance EP23 between the second spacing element and the third spacing element in the direction of the optical axis satisfy: 0.9<(|SAG31|+CT3)/EP23<1.5. By controlling the sum of relevant sizes of the object-side surface of the third lens and the center thickness of the third lens, and the ratio of this sum to the spacing distance between the second spacing element and the third spacing element in the direction of the optical axis, the relative uniformity of center and edge assembly thicknesses of the third lens and the curvature of the object-side surface of the third lens are controlled, which is conducive to molding stability of the third lens.

In exemplary implementations, an inner diameter d3s of an object-side surface of the third spacing element, an inner diameter d2s of an object-side surface of the second spacing element, and a refractive index N3 of the third lens satisfy: 1.8<d3s/d2s*N3<2.2. By controlling the ratio of the inner diameter of the object-side surface of the third spacing element to the inner diameter of the object-side surface of the second spacing element and the product of this ratio and the refractive index of the third lens, the purpose of controlling a light divergence range at the edge of the third lens is achieved, so as to control a relative illumination of the edge field-of-view, and to avoid the generation of dark corners.

In exemplary implementations, an inner diameter d4s of an object-side surface of the fourth spacing element, the inner diameter d3s of the object-side surface of the third spacing element, and a refractive index N4 of the fourth lens satisfy: 1.7<d4s/d3s*N4<2.5. By controlling the ratio of the inner diameter of the object-side surface of the fourth spacing element to the inner diameter of the object-side surface of the third spacing element and the product of this ratio and the refractive index of the fourth lens, the purpose of controlling a light divergence range at the edge of the fourth lens is achieved, so as to control the relative illumination of the edge field-of-view, and to avoid the generation of dark corners.

In exemplary implementations, an effective focal length f1 of the first lens and an effective focal length f5 of the fifth lens satisfy: −4.2<f1/f5<−2.1; an effective focal length f3 of the third lens and an effective focal length f of the camera lens assembly satisfy: −5.8<f3/f<−2.2; and an effective focal length f2 of the second lens and an effective focal length f4 of the fourth lens satisfy: 1.6<f2/f4<2.4. By controlling the effective focal length ratio of the first lens to the fifth lens, the effective focal length ratio of the third lens to the camera lens assembly, and the effective focal length ratio of the second lens to the fourth lens, the purpose of controlling the field-of-view of the camera lens assembly is achieved, which is conducive to the miniaturization of the lens assembly.

In exemplary implementations, an inner diameter d0s of the object-side end surface of the lens barrel and the effective focal length f of the camera lens assembly satisfy: 0.9<d0s/f<1.3. By controlling the ratio of the inner diameter of the object-side end surface of the lens barrel to the effective focal length of the camera lens assembly, it is conducive to controlling a size of the object-side end surface of the lens barrel and an overall size of the camera lens assembly.

In exemplary implementations, an outer diameter D4s of the object-side surface of the fourth spacing element, an effective radius DT42 of the image-side surface of the fourth lens, and the inner diameter d4s of the object-side surface of the fourth spacing element satisfy: 0.9<(D4s-DT42)/d4s<1.7. By controlling a support position difference between the fourth lens and the fourth spacing element and the inner diameter of the object-side surface of the fourth spacing element, it is conducive to support between the fourth lens and the fifth lens, and is conducive to the assembly stability.

In exemplary implementations, the effective focal length f2 of the second lens, the effective focal length f3 of the third lens, the inner diameter d2s of the object-side surface of the second spacing element, and the inner diameter d3s of the object-side surface of the third spacing element satisfy: −2.8<f3/f2/(d3s/d2s)<−1.4. By controlling the ratio of the effective focal length of the second lens to the effective focal length of the third lens, and the ratio of the inner diameter of the object-side surface of the third spacing element to the inner diameter of the object-side surface of the second spacing element, the ratio of the foregoing two ratios is controlled, so as to control the range of light at the edges of the lenses, to avoid the stray light while ensuring the optical parameters, thereby ensuring the image quality on the image plane.

In exemplary implementations, when the camera lens assembly includes the fifth spacing element, an outer diameter D4m of the image-side surface of the fourth spacing element, an outer diameter D5m of an image-side surface of the fifth spacing element, and a spacing distance EP45 between the fourth spacing element and the fifth spacing element in the direction of the optical axis satisfy: 18.4<(D4m+D5m)/EP45<26.2. By controlling the ratio of the sum of the outer diameter of the image-side surface of the fourth spacing element and the outer diameter of the image-side surface of the fifth spacing element, to the spacing distance between the fourth spacing element and the fifth spacing element in the direction of the optical axis, the uniformity of an edge structure of the fifth lens is controlled, which is conducive to the molding stability of the fifth lens and the support stability between preceding and succeeding lenses (which may be understood as the fourth lens and the sixth lens).

In exemplary implementations, a radius of curvature R7 of an object-side surface of the fourth lens, a radius of curvature R8 of the image-side surface of the fourth lens, a radius of curvature R3 of an object-side surface of the second lens, and a radius of curvature R4 of the image-side surface of the second lens satisfy: −1.1<(R7+R8)/(R3−R4)<−0.5; and the outer diameter D4m of the image-side surface of the fourth spacing element and an outer diameter D2s of the object-side surface of the second spacing element satisfy: 1.0<D4m/D2s<1.9. By controlling the ratio relationship between the radii of curvature of the fourth lens and the radii of curvature of the second lens, and controlling the ratio relationship between the outer diameters of the object-side surfaces of the fourth spacing element and the second spacing element, surface types of centers of the second lens and the fourth lens, and a mismatch discrepancy between the second lens and the fourth lens in a radial direction may be controlled, which is conducive to the refraction of light, as well as to controlling a radial width from becoming too large.

In exemplary implementations, when the camera lens assembly includes a sixth spacing element, an object-side surface and the image-side surface of the fifth lens each has at least one inflection point, and the object-side surface of the sixth lens has at least one inflection point; a distance YC52 from an inflection point nearest to the optical axis on the image-side surface of the fifth lens to the optical axis, a distance YC61 from an inflection point nearest to the optical axis on the object-side surface of the sixth lens to the optical axis, and a spacing distance EP46 between the fourth spacing element and the sixth spacing element in the direction of the optical axis satisfy: 1.4<(YC52+YC61)/EP46<2.2. By controlling the sum of the distance from the inflection point nearest to the optical axis on the image-side surface of the fifth lens to the optical axis and the distance from the inflection point nearest to the optical axis on the object-side surface of the sixth lens to the optical axis, and the ratio of this sum to the spacing distance between the fourth spacing element and the sixth spacing element in the direction of the optical axis, an overall structural uniformity of the fifth lens and the sixth lens is controlled, on the one hand, which is conducive to molding, and on the other hand, which controls an effective diameter of the sixth lens to not exceed the bottom of the lens barrel, and prevents the sixth lens from being abraded.

The inflection point, may be understood as, a location where the direction of surface curvature changes, i.e., the direction of surface curvature of a lens changes at the inflection point.

In exemplary implementations, the range of an F-number Fno of the camera lens assembly is: Fno is greater than 1.9 and less than 2.6.

A second aspect of the present disclosure provides a camera lens assembly, and the camera lens assembly may include an optical lens group. The optical lens group may sequentially include a first lens, a second lens, a third lens, a fourth lens, a fifth lens, and a sixth lens along an optical axis from an object side to an image side. The first lens, the second lens, the third lens, the fourth lens, the fifth lens, and the sixth lens all have refractive powers.

The camera lens assembly may include a spacing element group, and the spacing element group may include a third spacing element and a fourth spacing element. The third spacing element is disposed between an image-side surface of the third lens and the fourth lens and is in contact with the image-side surface of the third lens, e.g., the third spacing element is at least partially in contact with the image-side surface of the third lens. The fourth spacing element is disposed between an image-side surface of the fourth lens and the fifth lens and is in contact with the image-side surface of the fourth lens, e.g., the fourth spacing element is at least partially in contact with the image-side surface of the fourth lens.

A spacing distance EP34 between the third spacing element and the fourth spacing element in a direction of the optical axis, a maximal thickness CP4 of the fourth spacing element, and a center thickness CT4 of the fourth lens satisfy: 0.7<(EP34+CP4)/CT4<1.2. By controlling the sum of the spacing distance between the third spacing element and the fourth spacing element in the direction of the optical axis and the maximal thickness of the fourth spacing element, and the ratio of this sum to the center thickness of the fourth lens, the relative uniformity of center and edge assembly thicknesses of the fourth lens is controlled, which is conducive to molding stability of the fourth lens.

A third aspect of the present disclosure provides a camera lens assembly, and the camera lens assembly may include an optical lens group. The optical lens group may sequentially include a first lens, a second lens, a third lens, a fourth lens, a fifth lens, and a sixth lens along an optical axis from an object side to an image side. The first lens, the second lens, the third lens, the fourth lens, the fifth lens, and the sixth lens all have refractive powers.

The camera lens assembly may include a spacing element group, and the spacing element group may include a second spacing element and a third spacing element. The second spacing element is disposed between an image-side surface of the second lens and the third lens and is in contact with the image-side surface of the second lens, e.g., the second spacing element is at least partially in contact with the image-side surface of the second lens. The third spacing element is disposed between an image-side surface of the third lens and the fourth lens and is in contact with the image-side surface of the third lens, e.g., the third spacing element is at least partially in contact with the image-side surface of the third lens.

A distance SAG31 from an intersection point of an object-side surface of the third lens on the optical axis to a vertex of an effective radius of the object-side surface of the third lens on the optical axis, a center thickness CT3 of the third lens, and a spacing distance EP23 between the second spacing element and the third spacing element in a direction of the optical axis satisfy: 0.9<(|SAG31|+CT3)/EP23<1.5. By controlling the sum of relevant sizes of the object-side surface of the third lens and the center thickness of the third lens, and the ratio of this sum to the spacing distance between the second spacing element and the third spacing element in the direction of the optical axis, the relative uniformity of center and edge assembly thicknesses of the third lens and the curvature of the object-side surface of the third lens are controlled, which is conducive to molding stability of the third lens.

The camera lens assembly provided in the present disclosure has six lenses. The arrangement of high and low refractive indices of the lenses and the setting of the inflection points on the fifth lens are conducive to a wide-angle technical feature of the lens assembly. The inner diameter d0m of the image-side end surface of the lens barrel and half of the maximal field-of-view Semi-FOV of the camera lens assembly satisfy: 4.2 mm<d0m/tan(Semi-FOV)<5.0 mm, and the use of materials having high, low, and high refractive indices for the third lens, the fourth lens and the fifth lens may eliminate an axial chromatic aberration and a vertical axial chromatic aberration. The axial chromatic aberration affects diffuse spots in a central field-of-view, which may affect a peak performance of the central field-of-view. The vertical axial chromatic aberration may affect diffuse spots in an off-axis field-of-view as well as a peak expressiveness of a modulation transfer function (MTF), which significantly improves MTF degradation caused by short-wavelength dispersion in the off-axis field-of-view, consequently, tilt of the third lens and the fourth lens has a great impact on the peak performance. Through the spacing distance EP23 between the second spacing element and the third spacing element in the direction of the optical axis, the air gap T23 between the second lens and the third lens on the optical axis, and the air gap T34 between the third lens and the fourth lens on the optical axis satisfying: 0.9<EP23/(T23+T34)<1.8, and the spacing distance EP34 between the third spacing element and the fourth spacing element in the direction of the optical axis, the air gap T34 between the third lens and the fourth lens on the optical axis, and the air gap T45 between the fourth lens and the fifth lens on the optical axis satisfying: 0.8<EP34/(T34+T45)<2.6, the uniformity of edge and center-related sizes of the third lens and the fourth lens, as well as the air gaps preceding and succeeding the third lens and the fourth lens are controlled, which is conducive to reducing the sensitivity of assembly tilt of the third lens and the fourth lens, and to improving the stability of assembly performance of the third lens and the fourth lens.

It should be understood by those skilled in the art that the various results and advantages described in the present specification may be obtained by changing the number of the lenses/spacing elements constituting the camera lens assembly without departing from the technical solution claimed by the present disclosure.

Specific embodiments of the camera lens assembly that may be applicable to the above implementations are further described below with reference to the accompanying drawings.

### Embodiment 1

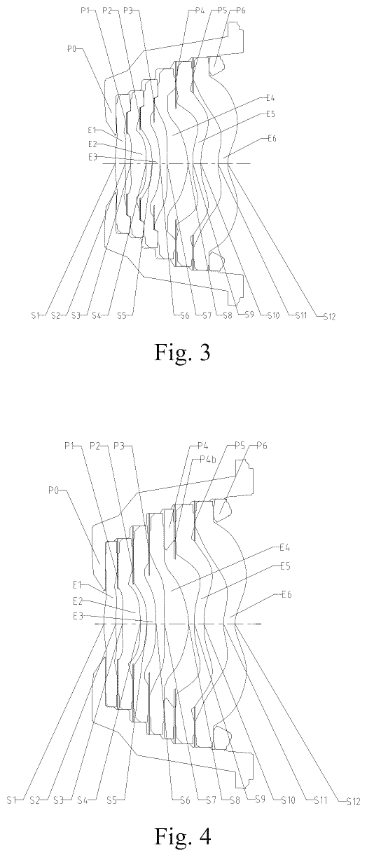

A camera lens assembly according to Embodiment 1 of the present disclosure is described below with reference to FIG. 3.

As shown in FIG. 3, the camera lens assembly includes an optical lens group, a spacing element group and a lens barrel.

The optical lens group sequentially includes a first lens E1, a second lens E2, a third lens E3, a fourth lens E4, a fifth lens E5, and a sixth lens E6. The first lens E1, the second lens E2, the third lens E3, the fourth lens E4, the fifth lens E5, and the sixth lens E6 are arranged along an optical axis from an object side to an image side. A diaphragm STO may be provided on an object side of an object-side surface of the first lens E1.

The first lens E1 has a positive refractive power, an object-side surface S1 of the first lens E1 is a convex surface, and an image-side surface S2 of the first lens E1 is a concave surface. The second lens E2 has a positive refractive power, an object-side surface S3 of the second lens E2 is a convex surface, and an image-side surface S4 of the second lens E2 is a convex surface. The third lens E3 has a negative refractive power, an object-side surface S5 of the third lens E3 is a concave surface, and an image-side surface S6 of the third lens E3 is a convex surface. The fourth lens E4 has a positive refractive power, an object-side surface S7 of the fourth lens E4 is a concave surface, and an image-side surface S8 of the fourth lens E4 is a convex surface. The fifth lens E5 has a negative refractive power, an object-side surface S9 of the fifth lens E5 is a convex surface, and an image-side surface S10 of the fifth lens E5 is a concave surface. The sixth lens E6 has a negative refractive power, an object-side surface S11 of the sixth lens E6 is a convex surface, and an image-side surface S12 of the sixth lens E6 is a concave surface. An optical filter or a protective glass has an object-side surface S13 (not shown) and an image-side surface S14 (not shown). Light from an object sequentially passes through the surfaces S1-S15 and finally forms an image on an image plane S15 (not shown).

The spacing element group includes a first spacing element P1, a second spacing element P2, a third spacing element P3, a fourth spacing element P4, a fifth spacing element P5, and a sixth spacing element P6. The optical lens group and the spacing element group are both disposed in the lens barrel P0. The spacing elements may block excess light from entering a next lens during imaging, while also allowing the lens and the lens barrel P0 to better support each other, thus enhancing structural stability of the camera lens assembly.

Table 2 shows a table of basic parameters of the camera lens assembly in Embodiment 1. Here, the units of a radius of curvature, a thickness/distance, and a focal length are all millimeters (mm).

TABLE 2

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | spherical | infinite | infinite | | | | |
| STO | spherical | infinite | −0.0271 | | | | |
| S1 | aspheric | 2.8364 | 0.2862 | 1.546 | 55.92 | 15.67 | 0.000 |
| S2 | aspheric | 4.0935 | 0.1577 | | | | 13.205 |
| S3 | aspheric | 5.9200 | 0.4323 | 1.546 | 55.92 | 5.54 | 40.930 |
| S4 | aspheric | −6.0104 | 0.1659 | | | | 3.894 |
| S5 | aspheric | −2.7228 | 0.2193 | 1.677 | 19.24 | −17.65 | −0.716 |
| S6 | aspheric | −3.6408 | 0.2040 | | | | 0.000 |
| S7 | aspheric | −7.2420 | 0.5813 | 1.546 | 55.92 | 2.57 | −15.777 |
| S8 | aspheric | −1.2089 | 0.1428 | | | | −4.896 |
| S9 | aspheric | 8.2033 | 0.2244 | 1.667 | 20.34 | −5.88 | 0.000 |
| S10 | aspheric | 2.6222 | 0.4766 | | | | 0.000 |
| S11 | aspheric | 1.0792 | 0.2754 | 1.546 | 55.92 | −4.94 | −5.289 |
| S12 | aspheric | 0.7012 | 0.4284 | | | | −2.620 |
| S13 | spherical | infinite | 0.2100 | 1.518 | 64.17 | | |
| S14 | spherical | infinite | 0.5828 | | | | |
| S15 | spherical | infinite | 0.0009 | | | | |

In this embodiment, the object-side surface and the image-side surface of any lens in the first lens E1 to the sixth lens E6 are both aspheric surfaces, and the surface type x of each aspheric lens may be defined using, but not limited to, the following aspheric formula:

$$x = \frac{{ch}^{2}}{1 + \sqrt{1 - ( k + 1 ) {c}^{2} {h}^{2}}} + \sum {Aih}^{i} \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 2 above); k is the conic coefficient; and Ai is the correction coefficient of the i-th order of the aspheric surface. Table 3 below gives the high-order coefficients A₄, A₆, A₈, A₁₀, A₁₂, A₁₄, A₁₆, A₁₈, A₂₀ and A₂₂ applicable to the aspheric surfaces S1-S12 in Embodiment 1.

TABLE 3

| surface | | | | | | | | | | |
|---|---|---|---|---|---|---|---|---|---|---|
| number | A4 | A6 | A8 | A10 | A12 | A14 | A16 | A18 | A20 | A22 |
| S1 | −4.71E−02 | −1.22E−03 | −5.45E−05 | 6.14E−05 | −9.13E−06 | −1.65E−06 | 0.00E+00 | 0.00E+00 | 0.00E+00 | 0.00E+00 |
| S2 | −1.08E−01 | −5.67E−04 | 2.27E−04 | −2.05E−04 | −1.30E−04 | 0.00E+00 | 0.00E+00 | 0.00E+00 | 0.00E+00 | 0.00E+00 |
| S3 | −1.30E−01 | −1.08E−02 | −2.63E−03 | −1.64E−03 | −6.98E−04 | −2.06E−04 | −4.83E−05 | 0.00E+00 | 0.00E+00 | 0.00E+00 |
| S4 | −1.83E−01 | −8.94E−03 | −1.52E−03 | −2.20E−03 | −3.10E−04 | 1.07E−04 | 0.00E+00 | 0.00E+00 | 0.00E+00 | 0.00E+00 |
| S5 | −1.58E−01 | 1.45E−02 | 5.76E−03 | −1.08E−03 | 1.37E−03 | 4.55E−04 | −1.97E−04 | −8.70E−05 | 0.00E+00 | 0.00E+00 |
| S6 | −1.05E−01 | −9.70E−05 | 8.36E−03 | −7.36E−04 | 1.50E−03 | 2.14E−04 | −2.13E−04 | 0.00E+00 | 0.00E+00 | 0.00E+00 |
| S7 | −2.60E−02 | −5.33E−02 | 1.75E−02 | 1.87E−03 | −3.54E−04 | −3.63E−04 | −6.24E−04 | 0.00E+00 | 0.00E+00 | 0.00E+00 |
| S8 | −9.42E−02 | −3.74E−02 | 3.69E−02 | 3.32E−03 | 2.04E−03 | −1.35E−03 | −6.77E−04 | −3.41E−04 | 0.00E+00 | 0.00E+00 |
| S9 | −3.60E−01 | −2.31E−01 | 9.52E−02 | −1.52E−02 | 8.43E−03 | −2.06E−03 | −4.36E−04 | −6.57E−04 | 2.36E−04 | 0.00E+00 |
| S10 | −1.06E+00 | −6.14E−02 | 1.06E−01 | −3.90E−02 | 9.83E−03 | −4.44E−03 | −8.68E−04 | 4.11E−04 | −5.43E−04 | 2.07E−04 |
| S11 | −1.73E+00 | 5.07E−01 | −1.19E−01 | 1.22E−02 | 7.27E−03 | 6.12E−04 | −3.43E−03 | −9.38E−04 | 7.98E−04 | 0.00E+00 |
| S12 | −2.17E+00 | 4.09E−01 | −1.72E−01 | 3.76E−02 | −1.46E−02 | 1.10E−02 | −1.93E−03 | 2.19E−03 | −1.02E−04 | 0.00E+00 |

Other parameters in Embodiment 1 are shown with specific reference to Table 10 and Table 11.

### Embodiment 2

A camera lens assembly according to Embodiment 2 of the present disclosure is described below with reference to FIG. 4.

As shown in FIG. 4, the camera lens assembly includes an optical lens group, a spacing element group and a lens barrel. A structure of the optical lens group is the same as the structure of the optical lens group in Embodiment 1. The spacing element group includes a first spacing element P1, a second spacing element P2, a third spacing element P3, a fourth spacing element P4, a fourth auxiliary spacing element P4b, a fifth spacing element P5, and a sixth spacing element P6.

The structure of the optical lens group in this embodiment is the same as the structure of the optical lens group in Embodiment 1, i.e., a table of basic parameters of the camera lens assembly in this embodiment is the same as that of Table 2, and a table of aspheric coefficients is the same as that of Table 3. A difference between this embodiment and Embodiment 1 is that structural dimensions of at least some of the elements in the spacing element group are different. For specific details, reference may be made to the data corresponding to Embodiment 2 in Table 11.

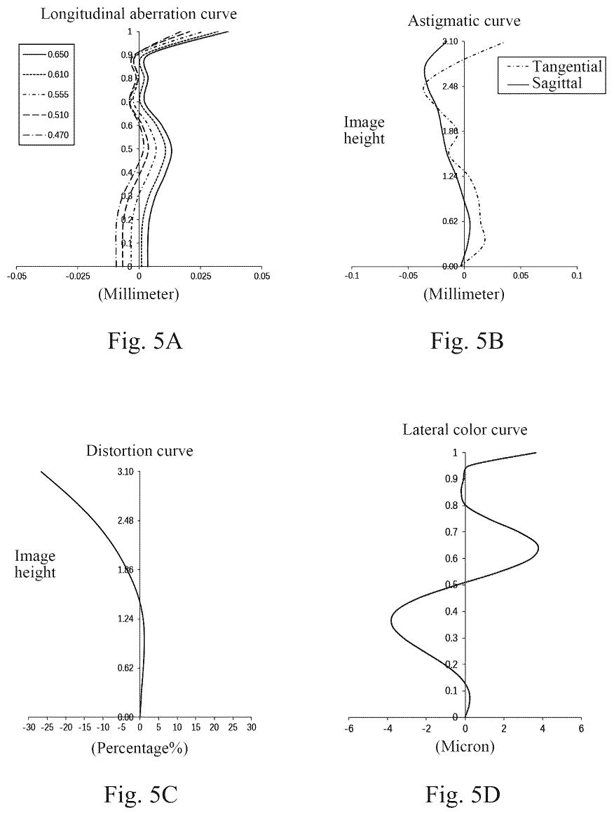

FIG. 5A illustrates a longitudinal aberration curve of the camara lens assembly in Embodiment 1 or Embodiment 2, representing deviations of focal points at which lights of different wavelengths passing through the camara lens assembly converge. FIG. 5B illustrates an astigmatic curve of the camara lens assembly in Embodiment 1 or Embodiment 2, representing a curvature of a tangential image plane and a curvature of a sagittal image plane corresponding to different image heights. FIG. 5C illustrates a distortion curve of the camara lens assembly in Embodiment 1 or Embodiment 2, representing amounts of distortion corresponding to different image heights. FIG. 5D illustrates a lateral color curve of the camera lens assembly in Embodiment 1 or Embodiment 2, representing deviations of different image heights on the image plane formed by light passing through the lens assembly. It can be seen from FIG. 5A to FIG. 5D that the camara lens assembly in Embodiment 1 or Embodiment 2 can achieve a good imaging quality.

### Embodiment 3

A camera lens assembly according to Embodiment 3 of the present disclosure is described below with reference to FIG. 6.

As shown in FIG. 6, the camera lens assembly includes an optical lens group, a spacing element group and a lens barrel.

The optical lens group includes a first lens E1, a second lens E2, a third lens E3, a fourth lens E4, a fifth lens E5, and a sixth lens E6. The first lens E1, the second lens E2, the third lens E3, the fourth lens E4, the fifth lens E5, and the sixth lens E6 are arranged sequentially along an optical axis from an object side to an image side. A diaphragm STO may be provided on an object side of an object-side surface of the first lens E1.

The first lens E1 has a positive refractive power, an object-side surface S1 of the first lens E1 is a convex surface, and an image-side surface S2 of the first lens E1 is a concave surface. The second lens E2 has a positive refractive power, an object-side surface S3 of the second lens E2 is a convex surface, and an image-side surface S4 of the second lens E2 is a convex surface. The third lens E3 has a negative refractive power, an object-side surface S5 of the third lens E3 is a concave surface, and an image-side surface S6 of the third lens E3 is a convex surface. The fourth lens E4 has a positive refractive power, an object-side surface S7 of the fourth lens E4 is a concave surface, and an image-side surface S8 of the fourth lens E4 is a convex surface. The fifth lens E5 has a negative refractive power, an object-side surface S9 of the fifth lens E5 is a convex surface, and an image-side surface S10 of the fifth lens E5 is a concave surface. The sixth lens E6 has a negative refractive power, an object-side surface S11 of the sixth lens E6 is a convex surface, and an image-side surface S12 of the sixth lens E6 is a concave surface. An optical filter or a protective glass has an object-side surface S13 (not shown) and an image-side surface S14 (not shown). Light from an object sequentially passes through the surfaces S1-S15 and finally forms an image on an image plane S15 (not shown).

The spacing element group includes a first spacing element P1, a second spacing element P2, a third spacing element P3, a fourth spacing element P4, a fifth spacing element P5, and a sixth spacing element P6. The optical lens group and the spacing element group are both disposed in the lens barrel P0. The spacing elements may block excess light from entering a next lens during imaging, while also allowing the lens and the lens barrel P0 to better support each other, thus enhancing structural stability of the camera lens assembly.

Table 4 shows a table of basic parameters of the camera lens assembly in Embodiment 3. Here, the units of a radius of curvature, a thickness/distance, and a focal length are all millimeters (mm).

TABLE 4

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | spherical | infinite | infinite | | | | |
| STO | spherical | infinite | −0.0348 | | | | |
| S1 | aspheric | 2.6141 | 0.2841 | 1.546 | 55.92 | 14.34 | 0.000 |
| S2 | aspheric | 3.7744 | 0.1652 | | | | 8.688 |
| S3 | aspheric | 5.7852 | 0.4250 | 1.546 | 55.92 | 5.70 | 39.692 |
| S4 | aspheric | −6.5458 | 0.1710 | | | | 3.319 |
| S5 | aspheric | −2.6057 | 0.2200 | 1.677 | 19.24 | −14.81 | −0.551 |
| S6 | aspheric | −3.6409 | 0.1320 | | | | 0.000 |
| S7 | aspheric | −7.2351 | 0.5711 | 1.546 | 55.92 | 2.55 | −31.450 |
| S8 | aspheric | −1.2004 | 0.1400 | | | | −5.065 |
| S9 | aspheric | 7.3466 | 0.2400 | 1.667 | 20.34 | −6.01 | 0.000 |
| S10 | aspheric | 2.5596 | 0.5011 | | | | 0.000 |
| S11 | aspheric | 1.0007 | 0.2700 | 1.546 | 55.92 | −5.21 | −4.984 |
| S12 | aspheric | 0.6696 | 0.4200 | | | | −2.722 |
| S13 | spherical | infinite | 0.2100 | 1.518 | 64.17 | | |
| S14 | spherical | infinite | 0.5600 | | | | |
| S15 | spherical | infinite | 0.0000 | | | | |

Table 5 below gives the high-order coefficients A₄, A₆, A₈, A₁₀, A₁₂, A₁₄, A₁₆, A₁₈, A₂₀ and A₂₂ applicable to the aspheric surfaces S1-S12 in Embodiment 3.

TABLE 5

| surface | | | | | | | | | | |
|---|---|---|---|---|---|---|---|---|---|---|
| number | A4 | A6 | A8 | A10 | A12 | A14 | A16 | A18 | A20 | A22 |
| S1 | −4.43E−02 | −1.51E−03 | −9.79E−05 | 4.84E−05 | −6.99E−06 | −2.78E−06 | 0.00E+00 | 0.00E+00 | 0.00E+00 | 0.00E+00 |
| S2 | −1.03E−01 | −1.41E−03 | 2.09E−04 | −1.77E−04 | −1.24E−04 | 0.00E+00 | 0.00E+00 | 0.00E+00 | 0.00E+00 | 0.00E+00 |
| S3 | −1.31E−01 | −1.18E−02 | −2.71E−03 | −1.68E−03 | −7.62E−04 | −2.42E−04 | −6.56E−05 | 0.00E+00 | 0.00E+00 | 0.00E+00 |
| S4 | −1.88E−01 | −9.92E−03 | −1.81E−03 | −2.31E−03 | −3.58E−04 | 1.04E−04 | 0.00E+00 | 0.00E+00 | 0.00E+00 | 0.00E+00 |
| S5 | −1.62E−01 | 1.60E−02 | 5.30E−03 | −5.71E−04 | 1.53E−03 | 4.26E−04 | −2.55E−04 | −9.93E−05 | 0.00E+00 | 0.00E+00 |
| S6 | −1.08E−01 | −3.11E−04 | 9.63E−03 | 1.25E−05 | 1.71E−03 | 1.45E−04 | −3.70E−04 | 0.00E+00 | 0.00E+00 | 0.00E+00 |
| S7 | −2.00E−02 | −5.36E−02 | 1.99E−02 | 2.10E−03 | 7.98E−05 | −6.49E−04 | −8.45E−04 | 0.00E+00 | 0.00E+00 | 0.00E+00 |
| S8 | −8.47E−02 | −3.93E−02 | 3.42E−02 | 3.11E−03 | 3.17E−03 | −1.40E−03 | −6.01E−04 | −4.56E−04 | 0.00E+00 | 0.00E+00 |
| S9 | −3.15E−01 | −2.35E−01 | 8.78E−02 | −1.35E−02 | 1.06E−02 | −2.88E−03 | −5.49E−04 | −7.85E−04 | 4.12E−04 | 0.00E+00 |
| S10 | −1.00E+00 | −7.76E−02 | 1.02E−01 | −3.32E−02 | 9.25E−03 | −5.28E−03 | −2.20E−04 | 7.07E−04 | −4.71E−04 | 6.04E−05 |
| S11 | −1.75E+00 | 5.04E−01 | −1.09E−01 | 7.08E−03 | 7.26E−03 | 2.35E−03 | −3.85E−03 | −9.83E−04 | 8.91E−04 | 0.00E+00 |
| S12 | −2.11E+00 | 3.98E−01 | −1.52E−01 | 2.94E−02 | −1.39E−02 | 1.16E−02 | −1.67E−03 | 1.35E−03 | −3.03E−04 | 0.00E+00 |

Other parameters in Embodiment 3 are shown with specific reference to Table 10 and Table 11.

### Embodiment 4

A camera lens assembly according to Embodiment 4 of the present disclosure is described below with reference to FIG. 7.

As shown in FIG. 7, the camera lens assembly includes an optical lens group, a spacing element group and a lens barrel. A structure of the optical lens group is the same as the structure of the optical lens group in Embodiment 3. The spacing element group includes a first spacing element P1, a second spacing element P2, a third spacing element P3, a fourth spacing element P4, a fourth auxiliary spacing element P4b, a fifth spacing element P5, and a sixth spacing element P6.

The structure of the optical lens group in this embodiment is the same as the structure of the optical lens group in Embodiment 3, i.e., a table of basic parameters of the camera lens assembly in this embodiment is the same as that of Table 4, and a table of aspheric coefficients is the same as that of Table 5. A difference between this embodiment and Embodiment 3 is that structural dimensions of at least some of the elements in the spacing element group are different. For specific details, reference may be made to the data corresponding to Embodiment 4 in Table 11.

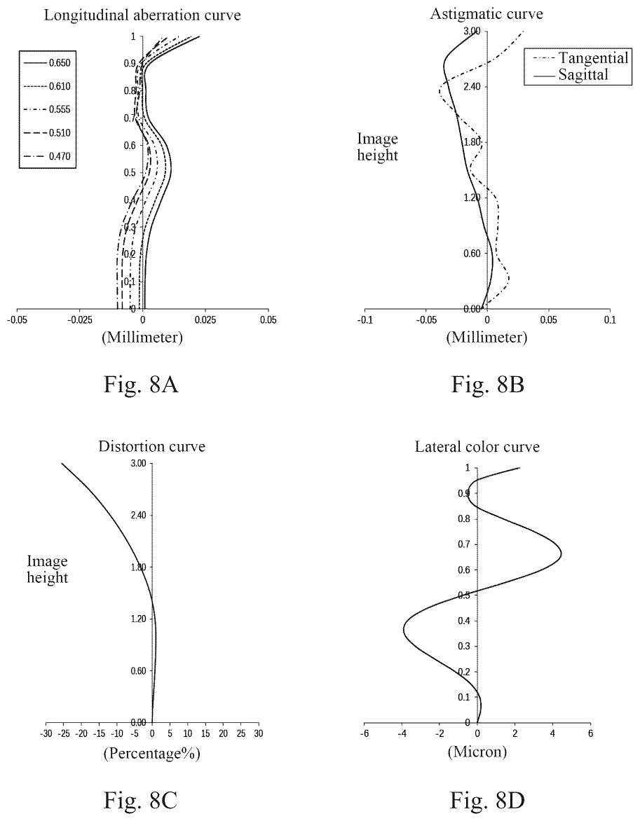

FIG. 8A illustrates a longitudinal aberration curve of the camara lens assembly in Embodiment 3 or Embodiment 4, representing deviations of focal points at which lights of different wavelengths passing through the camara lens assembly converge. FIG. 8B illustrates an astigmatic curve of the camara lens assembly in Embodiment 3 or Embodiment 4, representing a curvature of a tangential image plane and a curvature of a sagittal image plane corresponding to different image heights. FIG. 8C illustrates a distortion curve of the camara lens assembly in Embodiment 3 or Embodiment 4, representing amounts of distortion corresponding to different image heights. FIG. 8D illustrates a lateral color curve of the camera lens assembly in Embodiment 3 or Embodiment 4, representing deviations of different image heights on the image plane formed by light passing through the lens assembly. It can be seen from FIG. 8A to FIG. 8D that the camara lens assembly in Embodiment 3 or Embodiment 4 can achieve a good imaging quality.

### Embodiment 5

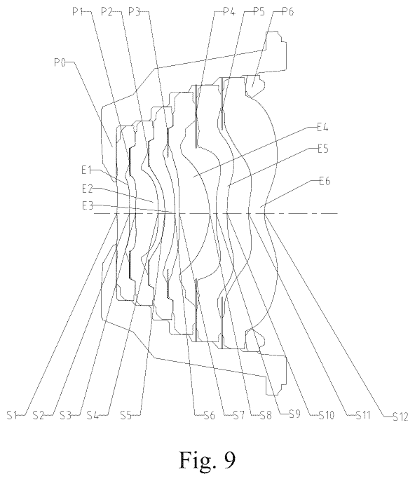

A camera lens assembly according to Embodiment 5 of the present disclosure is described below with reference to FIG. 9.

As shown in FIG. 9, the camera lens assembly includes an optical lens group, a spacing element group and a lens barrel.

The optical lens group includes a first lens E1, a second lens E2, a third lens E3, a fourth lens E4, a fifth lens E5, and a sixth lens E6. The first lens E1, the second lens E2, the third lens E3, the fourth lens E4, the fifth lens E5, and the sixth lens E6 are arranged sequentially along an optical axis from an object side to an image side. A diaphragm STO may be provided on an object side of an object-side surface of the first lens E1.

The first lens E1 has a positive refractive power, an object-side surface S1 of the first lens E1 is a convex surface, and an image-side surface S2 of the first lens E1 is a concave surface. The second lens E2 has a positive refractive power, an object-side surface S3 of the second lens E2 is a convex surface, and an image-side surface S4 of the second lens E2 is a convex surface. The third lens E3 has a negative refractive power, an object-side surface S5 of the third lens E3 is a concave surface, and an image-side surface S6 of the third lens E3 is a convex surface. The fourth lens E4 has a positive refractive power, an object-side surface S7 of the fourth lens E4 is a concave surface, and an image-side surface S8 of the fourth lens E4 is a convex surface. The fifth lens E5 has a negative refractive power, an object-side surface S9 of the fifth lens E5 is a concave surface, and an image-side surface S10 of the fifth lens E5 is a concave surface. The sixth lens E6 has a negative refractive power, an object-side surface S11 of the sixth lens E6 is a convex surface, and an image-side surface S12 of the sixth lens E6 is a concave surface. An optical filter or a protective glass has an object-side surface S13 (not shown) and an image-side surface S14 (not shown). Light from an object sequentially passes through the surfaces S1-S15 and finally forms an image on an image plane S15 (not shown).

The spacing element group includes a first spacing element P1, a second spacing element P2, a third spacing element P3, a fourth spacing element P4, a fifth spacing element P5, and a sixth spacing element P6. The optical lens group and the spacing element group are both disposed in the lens barrel P0. The spacing elements may block excess light from entering a next lens during imaging, while also allowing the lens and the lens barrel P0 to better support each other, thus enhancing structural stability of the camera lens assembly.

Table 6 shows a table of basic parameters of the camera lens assembly in Embodiment 5. Here, the units of a radius of curvature, a thickness/distance, and a focal length are all millimeters (mm).

TABLE 6

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | spherical | infinite | infinite | | | | |
| STO | spherical | infinite | 0.0190 | | | | |
| S1 | aspheric | 7.1381 | 0.2673 | 1.546 | 55.92 | 27.91 | 0.000 |
| S2 | aspheric | 13.2591 | 0.1289 | | | | −35.582 |
| S3 | aspheric | 4.83415 | 0.4818 | 1.546 | 55.92 | 4.07 | 25.501 |
| S4 | aspheric | −3.9638 | 0.1394 | | | | 6.187 |
| S5 | aspheric | −2.4699 | 0.2100 | 1.662 | 20.31 | −8.17 | 2.107 |
| S6 | aspheric | −4.7026 | 0.1000 | | | | 0.000 |
| S7 | aspheric | −7.6461 | 0.6448 | 1.546 | 55.92 | 2.36 | 12.623 |
| S8 | aspheric | −1.1349 | 0.1360 | | | | −3.582 |
| S9 | aspheric | −28.8651 | 0.2335 | 1.618 | 24.74 | −6.87 | 0.000 |
| S10 | aspheric | 4.9911 | 0.4558 | | | | 0.000 |
| S11 | aspheric | 1.2182 | 0.3363 | 1.546 | 55.92 | −3.66 | −9.507 |
| S12 | aspheric | 0.6830 | 0.4200 | | | | −3.337 |
| S13 | spherical | infinite | 0.2100 | 1.518 | 64.17 | | |
| S14 | spherical | infinite | 0.6173 | | | | |
| S15 | spherical | infinite | 0.0000 | | | | |

Table 7 below gives the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 5.

TABLE 7

| surface | | | | | | | |
|---|---|---|---|---|---|---|---|
| number | A4 | A6 | A8 | A10 | A12 | A14 | A16 |
| S1 | −3.78E−02 | −3.57E−04 | −7.62E−05 | 4.67E−06 | −7.06E−06 | −3.31E−06 | 0.00E+00 |
| S2 | −9.62E−02 | 2.11E−03 | −4.72E−04 | −2.46E−04 | −4.77E−05 | 0.00E+00 | 0.00E+00 |
| S3 | −1.34E−01 | −1.04E−02 | −4.38E−03 | −1.96E−03 | −6.35E−04 | −1.80E−04 | −4.92E−05 |
| S4 | −1.95E−01 | −1.35E−02 | −4.19E−03 | −2.43E−03 | −2.17E−05 | −3.30E−05 | 0.00E+00 |
| S5 | −1.37E−01 | 2.88E−02 | 5.65E−03 | 1.81E−04 | 1.02E−03 | −6.84E−04 | −9.08E−05 |
| S6 | −1.11E−01 | 1.93E−02 | 9.61E−03 | −9.34E−04 | 4.09E−04 | −1.44E−03 | 3.01E−04 |
| S7 | −4.97E−02 | −1.15E−02 | 1.87E−02 | −1.20E−03 | 7.42E−06 | −1.22E−03 | 3.82E−04 |
| S8 | −1.56E−01 | −4.77E−02 | 2.20E−02 | −5.25E−03 | 4.91E−03 | −9.32E−04 | 4.89E−04 |
| S9 | −5.58E−02 | −2.43E−01 | 3.18E−02 | −2.87E−02 | 3.73E−03 | −1.25E−03 | 1.34E−03 |
| S10 | −3.89E−01 | −1.28E−01 | 8.57E−02 | −2.85E−02 | 1.46E−02 | 1.72E−03 | 2.17E−04 |
| S11 | −1.31E+00 | 3.73E−01 | −6.53E−02 | −4.82E−03 | 9.57E−03 | 6.50E−03 | −4.88E−03 |
| S12 | −1.64E+00 | 3.29E−01 | −1.32E−01 | 3.36E−02 | −1.30E−02 | 7.53E−03 | −3.70E−03 |

| surface | | | | | | | |
|---|---|---|---|---|---|---|---|
| number | A18 | A20 | A22 | A24 | A26 | A28 | A30 |
| S1 | 0.00E+00 | 0.00E+00 | 0.00E+00 | 0.00E+00 | 0.00E+00 | 0.00E+00 | 0.00E+00 |
| S2 | 0.00E+00 | 0.00E+00 | 0.00E+00 | 0.00E+00 | 0.00E+00 | 0.00E+00 | 0.00E+00 |
| S3 | 0.00E+00 | 0.00E+00 | 0.00E+00 | 0.00E+00 | 0.00E+00 | 0.00E+00 | 0.00E+00 |
| S4 | 0.00E+00 | 0.00E+00 | 0.00E+00 | 0.00E+00 | 0.00E+00 | 0.00E+00 | 0.00E+00 |
| S5 | 1.43E−05 | 0.00E+00 | 0.00E+00 | 1.43E−05 | 0.00E+00 | 0.00E+00 | 1.43E−05 |
| S6 | 0.00E+00 | 0.00E+00 | 0.00E+00 | 0.00E+00 | 0.00E+00 | 0.00E+00 | 0.00E+00 |
| S7 | 0.00E+00 | 0.00E+00 | 0.00E+00 | 0.00E+00 | 0.00E+00 | 0.00E+00 | 0.00E+00 |
| S8 | −1.11E−04 | 0.00E+00 | 0.00E+00 | −1.11E−04 | 0.00E+00 | 0.00E+00 | −1.11E−04 |
| S9 | 2.47E−04 | 3.44E−04 | 0.00E+00 | 2.47E−04 | 3.44E−04 | 0.00E+00 | 2.47E−04 |
| S10 | −2.28E−04 | −9.18E−04 | 4.36E−05 | −2.28E−04 | −9.18E−04 | 4.36E−05 | −2.28E−04 |
| S11 | −2.00E−03 | 1.27E−03 | 0.00E+00 | −2.00E−03 | 1.27E−03 | 0.00E+00 | −2.00E−03 |
| S12 | 1.93E−03 | −2.95E−04 | 0.00E+00 | 1.93E−03 | −2.95E−04 | 0.00E+00 | 1.93E−03 |

Other parameters in Embodiment 5 are shown with specific reference to Table 10 and Table 11.

### Embodiment 6

A camera lens assembly according to Embodiment 6 of the present disclosure is described below with reference to FIG. 10.

As shown in FIG. 10, the camera lens assembly includes an optical lens group, a spacing element group and a lens barrel. A structure of the optical lens group is the same as the structure of the optical lens group in Embodiment 3. The spacing element group includes a first spacing element P1, a second spacing element P2, a third spacing element P3, a fourth spacing element P4, a fourth auxiliary spacing element P4b, a fifth spacing element P5, and a sixth spacing element P6.

The structure of the optical lens group in this embodiment is the same as the structure of the optical lens group in Embodiment 5, i.e., a table of basic parameters of the camera lens assembly in this embodiment is the same as that of Table 6, and a table of aspheric coefficients is the same as that of Table 7. A difference between this embodiment and Embodiment 5 is that structural dimensions of at least some of the elements in the spacing element group are different. For specific details, reference may be made to the data corresponding to Embodiment 6 in Table 11.

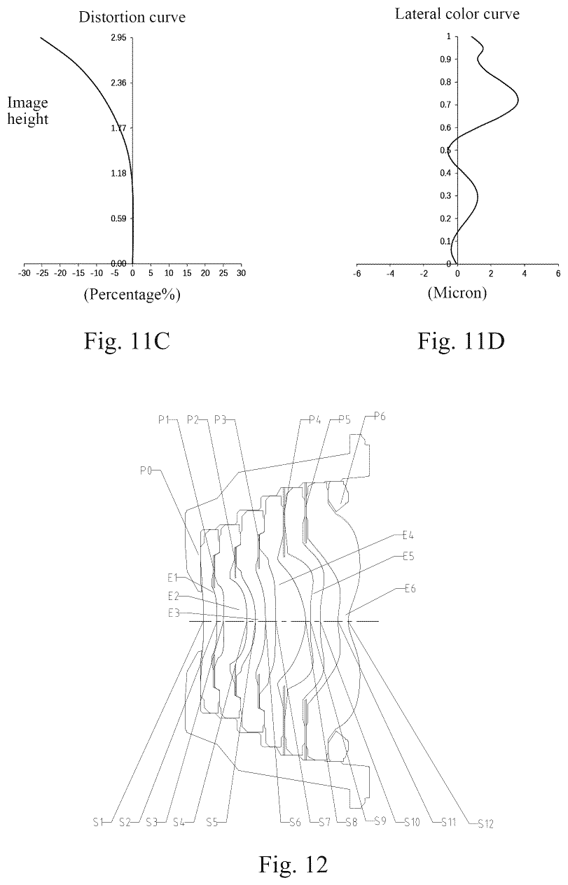

FIG. 11A illustrates a longitudinal aberration curve of the camara lens assembly in Embodiment 5 or Embodiment 6, representing deviations of focal points at which lights of different wavelengths passing through the camara lens assembly converge. FIG. 11B illustrates an astigmatic curve of the camara lens assembly in Embodiment 5 or Embodiment 6, representing a curvature of a tangential image plane and a curvature of a sagittal image plane corresponding to different image heights. FIG. 11C illustrates a distortion curve of the camara lens assembly in Embodiment 5 or Embodiment 6, representing amounts of distortion corresponding to different image heights. FIG. 11D illustrates a lateral color curve of the camera lens assembly in Embodiment 5 or Embodiment 6, representing deviations of different image heights on the image plane formed by light passing through the lens assembly. It can be seen from FIG. 11A to FIG. 11D that the camara lens assembly in Embodiment 5 or Embodiment 6 can achieve a good imaging quality.

### Embodiment 7

A camera lens assembly according to Embodiment 7 of the present disclosure is described below with reference to FIG. 12.

As shown in FIG. 12, the camera lens assembly includes an optical lens group, a spacing element group and a lens barrel.

The optical lens group includes a first lens E1, a second lens E2, a third lens E3, a fourth lens E4, a fifth lens E5, and a sixth lens E6. The first lens E1, the second lens E2, the third lens E3, the fourth lens E4, the fifth lens E5, and the sixth lens E6 are arranged sequentially along an optical axis from an object side to an image side. A diaphragm STO may be provided on an object side of an object-side surface of the first lens E1.

The first lens E1 has a positive refractive power, an object-side surface S1 of the first lens E1 is a convex surface, and an image-side surface S2 of the first lens E1 is a convex surface. The second lens E2 has a positive refractive power, an object-side surface S3 of the second lens E2 is a convex surface, and an image-side surface S4 of the second lens E2 is a convex surface. The third lens E3 has a negative refractive power, an object-side surface S5 of the third lens E3 is a concave surface, and an image-side surface S6 of the third lens E3 is a convex surface. The fourth lens E4 has a positive refractive power, an object-side surface S7 of the fourth lens E4 is a concave surface, and an image-side surface S8 of the fourth lens E4 is a convex surface. The fifth lens E5 has a negative refractive power, an object-side surface S9 of the fifth lens E5 is a concave surface, and an image-side surface S10 of the fifth lens E5 is a concave surface. The sixth lens E6 has a negative refractive power, an object-side surface S11 of the sixth lens E6 is a convex surface, and an image-side surface S12 of the sixth lens E6 is a concave surface. An optical filter or a protective glass has an object-side surface S13 (not shown) and an image-side surface S14 (not shown). Light from an object sequentially passes through the surfaces S1-S15 and finally forms an image on an image plane S15 (not shown).

The spacing element group includes a first spacing element P1, a second spacing element P2, a third spacing element P3, a fourth spacing element P4, a fifth spacing element P5, and a sixth spacing element P6. The optical lens group and the spacing element group are both disposed in the lens barrel P0. The spacing elements may block excess light from entering a next lens during imaging, while also allowing the lens and the lens barrel P0 to better support each other, thus enhancing structural stability of the camera lens assembly.

Table 8 shows a table of basic parameters of the camera lens assembly in Embodiment 7. Here, the units of a radius of curvature, a thickness/distance, and a focal length are all millimeters (mm).

TABLE 8

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | spherical | infinite | infinite | | | | |
| STO | spherical | infinite | 0.0286 | | | | |
| S1 | aspheric | 17.0112 | 0.2945 | 1.546 | 55.92 | 16.80 | 0.000 |
| S2 | aspheric | −19.7532 | 0.1361 | | | | 50.000 |
| S3 | aspheric | 4.8438 | 0.5042 | 1.546 | 55.92 | 3.90 | 20.021 |
| S4 | aspheric | −3.6627 | 0.1818 | | | | 9.446 |
| S5 | aspheric | −2.4172 | 0.2122 | 1.662 | 20.29 | −7.26 | 1.183 |
| S6 | aspheric | −5.0335 | 0.2194 | | | | 0.000 |
| S7 | aspheric | −7.4363 | 0.6360 | 1.546 | 55.92 | 2.03 | 13.813 |
| S8 | aspheric | −0.9917 | 0.1014 | | | | −4.105 |
| S9 | aspheric | −18.9316 | 0.2109 | 1.676 | 19.27 | −7.52 | 0.000 |
| S10 | aspheric | 6.9871 | 0.3807 | | | | 0.000 |
| S11 | aspheric | 1.2826 | 0.2187 | 1.546 | 55.92 | −2.54 | −13.671 |
| S12 | aspheric | 0.6259 | 0.4200 | | | | −3.438 |
| S13 | spherical | infinite | 0.2100 | 1.518 | 64.17 | | |
| S14 | spherical | infinite | 0.6121 | | | | |
| S15 | spherical | infinite | | | | | |

Table 9 below gives the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 7.

TABLE 9

| surface | | | | | | | |
|---|---|---|---|---|---|---|---|
| number | A4 | A6 | A8 | A10 | A12 | A14 | A16 |
| S1 | −2.93E−02 | −1.92E−04 | −7.14E−05 | 1.82E−06 | −4.88E−06 | −1.74E−06 | 0.00E+00 |
| S2 | −7.73E−02 | 2.02E−03 | −6.33E−04 | −1.50E−04 | −3.40E−05 | 0.00E+00 | 0.00E+00 |
| S3 | −1.17E−01 | −9.68E−03 | −4.26E−03 | −1.54E−03 | −5.05E−04 | −1.47E−04 | −3.79E−05 |
| S4 | −1.76E−01 | −1.45E−02 | −4.02E−03 | −1.86E−03 | −2.34E−04 | −7.56E−05 | 0.00E+00 |
| S5 | −1.23E−01 | 2.75E−02 | 4.98E−03 | 8.55E−05 | 9.68E−04 | −3.02E−04 | −6.34E−05 |
| S6 | −1.07E−01 | 1.27E−02 | 5.74E−03 | 1.43E−05 | 1.35E−03 | −3.16E−04 | 9.58E−05 |
| S7 | −3.35E−02 | −3.01E−02 | 1.74E−02 | 2.66E−03 | 6.85E−04 | −6.12E−04 | −2.08E−04 |
| S8 | −1.12E−01 | −3.53E−02 | 2.53E−02 | 4.27E−04 | 3.63E−03 | −8.12E−04 | 7.08E−05 |
| S9 | −1.79E−01 | −2.09E−01 | 4.83E−02 | −1.47E−02 | 5.04E−03 | −5.35E−04 | 9.13E−04 |
| S10 | −4.67E−01 | −1.10E−01 | 7.68E−02 | −1.79E−02 | 9.40E−03 | 1.99E−04 | −1.22E−03 |
| S11 | −1.20E+00 | 2.72E−01 | −5.71E−02 | 5.02E−03 | 7.74E−03 | −1.42E−04 | −3.22E−03 |
| S12 | −1.49E+00 | 2.91E−01 | −1.41E−01 | 4.16E−02 | −1.29E−02 | 3.84E−03 | −2.32E−03 |

| surface | | | | | | | |
|---|---|---|---|---|---|---|---|
| number | A18 | A20 | A22 | A24 | A26 | A28 | A30 |
| S1 | 0.00E+00 | 0.00E+00 | 0.00E+00 | 0.00E+00 | 0.00E+00 | 0.00E+00 | 0.00E+00 |
| S2 | 0.00E+00 | 0.00E+00 | 0.00E+00 | 0.00E+00 | 0.00E+00 | 0.00E+00 | 0.00E+00 |
| S3 | 0.00E+00 | 0.00E+00 | 0.00E+00 | 0.00E+00 | 0.00E+00 | 0.00E+00 | 0.00E+00 |
| S4 | 0.00E+00 | 0.00E+00 | 0.00E+00 | 0.00E+00 | 0.00E+00 | 0.00E+00 | 0.00E+00 |
| S5 | −1.68E−05 | 0.00E+00 | 0.00E+00 | −1.68E−05 | 0.00E+00 | 0.00E+00 | −1.68E−05 |
| S6 | 0.00E+00 | 0.00E+00 | 0.00E+00 | 0.00E+00 | 0.00E+00 | 0.00E+00 | 0.00E+00 |
| S7 | 0.00E+00 | 0.00E+00 | 0.00E+00 | 0.00E+00 | 0.00E+00 | 0.00E+00 | 0.00E+00 |
| S8 | −1.79E−04 | 0.00E+00 | 0.00E+00 | −1.79E−04 | 0.00E+00 | 0.00E+00 | −1.79E−04 |
| S9 | 3.69E−04 | 2.31E−04 | 0.00E+00 | 3.69E−04 | 2.31E−04 | 0.00E+00 | 3.69E−04 |
| S10 | −3.63E−04 | −5.60E−04 | 1.81E−04 | −3.63E−04 | −5.60E−04 | 1.81E−04 | −3.63E−04 |
| S11 | −6.61E−04 | 4.32E−04 | 0.00E+00 | −6.61E−04 | 4.32E−04 | 0.00E+00 | −6.61E−04 |
| S12 | 9.04E−04 | −6.44E−04 | 0.00E+00 | 9.04E−04 | −6.44E−04 | 0.00E+00 | 9.04E−04 |

Other parameters in Embodiment 7 are shown with specific reference to Table 10 and Table 11.

### Embodiment 8

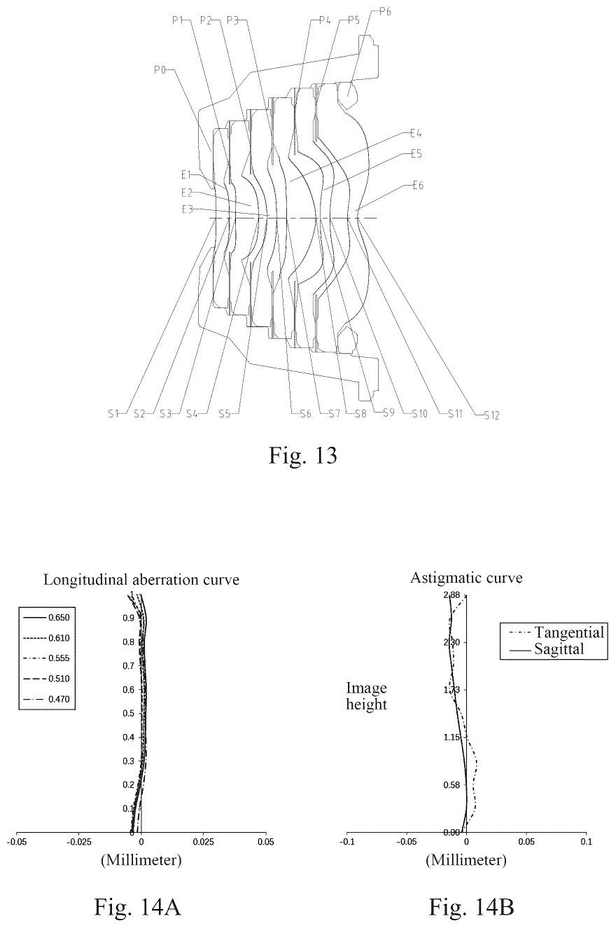

A camera lens assembly according to Embodiment 8 of the present disclosure is described below with reference to FIG. 13.

As shown in FIG. 13, the camera lens assembly includes an optical lens group, a spacing element group and a lens barrel. A structure of the optical lens group is the same as the structure of the optical lens group in Embodiment 3. The spacing element group includes a first spacing element P1, a second spacing element P2, a third spacing element P3, a fourth spacing element P4, a fifth spacing element P5, and a sixth spacing element P6.

The structure of the optical lens group in this embodiment is the same as the structure of the optical lens group in Embodiment 7, i.e., a table of basic parameters of the camera lens assembly in this embodiment is the same as that of Table 8, and a table of aspheric coefficients is the same as that of Table 9. A difference between this embodiment and Embodiment 7 is that structural dimensions of at least some of the elements in the spacing element group are different. For specific details, reference may be made to the data corresponding to Embodiment 8 in Table 11.

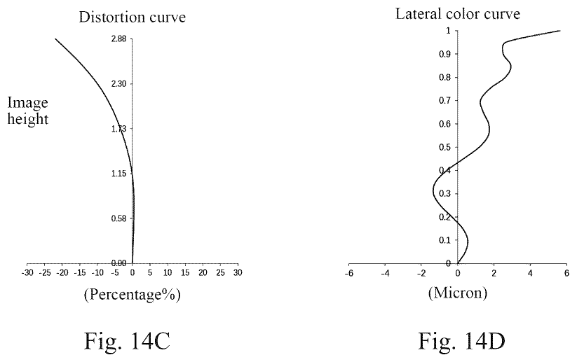

FIG. 14A illustrates a longitudinal aberration curve of the camara lens assembly in Embodiment 7 or Embodiment 8, representing deviations of focal points at which lights of different wavelengths passing through the camara lens assembly converge. FIG. 14B illustrates an astigmatic curve of the camara lens assembly in Embodiment 7 or Embodiment 8, representing a curvature of a tangential image plane and a curvature of a sagittal image plane corresponding to different image heights. FIG. 14C illustrates a distortion curve of the camara lens assembly in Embodiment 7 or Embodiment 8, representing amounts of distortion corresponding to different image heights. FIG. 14D illustrates a lateral color curve of the camera lens assembly in Embodiment 7 or Embodiment 8, representing deviations of different image heights on the image plane formed by light passing through the lens assembly. It can be seen from FIG. 14A to FIG. 14D that the camara lens assembly in Embodiment 7 or Embodiment 8 can achieve a good imaging quality.

Table 10 shows values of optical parameters such as Semi-FOV, Fno, DT42, SAG31, SAG42, YC52, and YC61 for each of the embodiments in Embodiments 1-8.

TABLE 10

| | embodiment | | | | | | | |
|---|---|---|---|---|---|---|---|---|
| parameter | 1 | 2 | 3 | 4 | 5 | 6 | 7 | 8 |

| | | | | |
|---|---|---|---|---|
| Semi-FOV(°) | 53.57 | 52.89 | 52.12 | 50.50 |
| Fno | 2.00 | 2.00 | 2.40 | 2.50 |
| f(mm) | 3.12 | 3.05 | 3.08 | 3.04 |
| DT42(mm) | 1.3587 | 1.3244 | 1.2661 | 1.2707 |
| SAG31(mm) | −0.30 | −0.32 | −0.31 | −0.29 |
| SAG42(mm) | −0.54 | −0.51 | −0.64 | −0.59 |
| YC52(mm) | 1.12 | 1.13 | 1.01 | 0.88 |
| YC61(mm) | 0.71 | 0.71 | 0.62 | 0.55 |

Table 11 shows values of parameters such as d2s, D2s, d3s, d4s, D4s, D4m, D5m, d0s, d0m, D0s, D0m, EP23, EP34, CP4, EP45, and EP46 for each of the embodiments in Embodiments 1-8. Here, some of the above parameters may be obtained from measuring with reference to labelling shown in FIG. 1 and FIG. 2, and the units of the parameters listed in Table 11 are all millimeters (mm).

TABLE 11

| | embodiment | | | | | | | |
|---|---|---|---|---|---|---|---|---|
| parameter | 1 | 2 | 3 | 4 | 5 | 6 | 7 | 8 |
| d2s | 1.889 | 1.909 | 1.919 | 1.929 | 1.959 | 1.941 | 1.834 | 1.901 |
| D2s | 3.060 | 4.600 | 2.933 | 4.210 | 2.960 | 3.980 | 3.060 | 4.600 |
| d3s | 2.308 | 2.328 | 2.373 | 2.338 | 2.353 | 2.271 | 2.228 | 2.282 |
| d4s | 3.082 | 3.610 | 3.040 | 3.100 | 2.745 | 3.370 | 2.715 | 2.709 |
| D4s | 5.600 | 5.400 | 5.190 | 4.800 | 5.300 | 4.900 | 5.540 | 5.500 |
| D4m | 5.600 | 5.400 | 5.190 | 4.800 | 5.300 | 4.900 | 5.540 | 5.500 |
| D5m | 5.800 | 5.780 | 5.400 | 5.500 | 5.600 | 5.300 | 5.740 | 5.680 |
| d0s | 3.415 | 3.415 | 3.409 | 3.549 | 3.148 | 3.138 | 3.138 | 3.138 |
| d0m | 6.057 | 6.077 | 5.828 | 5.890 | 5.897 | 5.760 | 5.997 | 5.937 |
| D0s | 4.623 | 4.623 | 4.350 | 4.350 | 4.392 | 4.290 | 4.592 | 4.592 |
| D0m | 7.751 | 7.731 | 7.427 | 7.367 | 7.511 | 7.450 | 7.751 | 7.751 |
| EP23 | 0.373 | 0.373 | 0.437 | 0.368 | 0.387 | 0.354 | 0.476 | 0.460 |
| EP34 | 0.585 | 0.343 | 0.526 | 0.327 | 0.572 | 0.394 | 0.510 | 0.466 |
| CP4 | 0.030 | 0.250 | 0.030 | 0.265 | 0.030 | 0.250 | 0.030 | 0.022 |
| EP45 | 0.452 | 0.482 | 0.456 | 0.486 | 0.521 | 0.551 | 0.432 | 0.440 |
| EP46 | 0.917 | 0.949 | 0.880 | 0.902 | 1.043 | 1.085 | 0.924 | 0.924 |

Table 12 shows values of the conditional expressions for each of the embodiments in Embodiments 1-8.

TABLE 12

| conditional | embodiment | | | | | | | |
|---|---|---|---|---|---|---|---|---|
| expression | 1 | 2 | 3 | 4 | 5 | 6 | 7 | 8 |
| d0m/tan(Semi-FOV) | 4.47 | 4.49 | 4.41 | 4.46 | 4.59 | 4.48 | 4.94 | 4.89 |
| EP23/(T23 + T34) | 1.01 | 1.01 | 1.44 | 1.21 | 1.62 | 1.48 | 1.19 | 1.15 |
| EP34/(T34 + T45) | 1.69 | 0.99 | 1.93 | 1.20 | 2.42 | 1.67 | 1.59 | 1.45 |
| (D0m/D0s)*Semi-FOV) | 89.81 | 89.58 | 90.30 | 89.57 | 89.13 | 90.51 | 85.24 | 85.24 |
| (EP34 + CP4)/CT4 | 1.06 | 1.02 | 0.97 | 1.04 | 0.93 | 1.00 | 0.85 | 0.77 |
| f4/(\|SAG42\| + EP34) | 2.29 | 2.92 | 2.46 | 3.05 | 1.94 | 2.27 | 1.85 | 1.92 |
| (\|SAG31\| + CT3)/EP23 | 1.38 | 1.38 | 1.23 | 1.46 | 1.36 | 1.48 | 1.06 | 1.10 |
| d3s/d2s*N3 | 2.05 | 2.05 | 2.07 | 2.03 | 2.00 | 1.94 | 2.02 | 2.00 |
| d4s/d3s*N4 | 2.06 | 2.40 | 1.98 | 2.05 | 1.80 | 2.29 | 1.88 | 1.84 |
| f1/f5 | −2.67 | −2.67 | −2.38 | −2.38 | −4.06 | −4.06 | −2.23 | −2.23 |
| f3/f | −5.66 | −5.66 | −4.86 | −4.86 | −2.66 | −2.66 | −2.39 | −2.39 |
| f2/f4 | 2.15 | 2.15 | 2.23 | 2.23 | 1.72 | 1.72 | 1.93 | 1.93 |
| d0s/f | 1.10 | 1.10 | 1.12 | 1.17 | 1.02 | 1.02 | 1.03 | 1.03 |
| (D4s − DT42)/d4s | 1.38 | 1.12 | 1.27 | 1.12 | 1.47 | 1.08 | 1.57 | 1.56 |
| f3/f2/(d3s/d2s) | −2.61 | −2.61 | −2.10 | −2.14 | −1.67 | −1.72 | −1.53 | −1.55 |
| (D4m + D5m)/EP45 | 25.22 | 23.20 | 23.22 | 21.19 | 20.92 | 18.51 | 26.11 | 25.41 |
| (R7 + R8)/(R3 − R4) | −0.71 | −0.71 | −0.68 | −0.68 | −1.00 | −1.00 | −0.99 | −0.99 |
| D4m/D2s | 1.83 | 1.17 | 1.77 | 1.14 | 1.79 | 1.23 | 1.81 | 1.20 |
| (YC52 + YC61)/EP46 | 2.00 | 1.93 | 2.09 | 2.04 | 1.56 | 1.50 | 1.55 | 1.55 |

The present disclosure further provides an imaging apparatus having an electronic photosensitive element which may be a photosensitive charge-coupled device (CCD) or complementary metal-oxide semiconductor element (CMOS). The imaging apparatus may be an independent imaging device such as a digital camera, or may be an imaging module integrated in a mobile electronic device such as a mobile phone. The imaging apparatus is equipped with the camera lens assembly described above.

The foregoing is only a description for the preferred embodiments of the present disclosure and the applied technical principles. It should be appreciated by those skilled in the art that the inventive scope of the present disclosure is not limited to the technical solution formed by the particular combinations of the above technical features. The inventive scope should also cover other technical solutions formed by any combination of the above technical features or equivalent features thereof without departing from the inventive concept, for example, technical solutions formed by replacing the features as disclosed in the present disclosure with (but not limited to) technical features with similar functions.

What is claimed is:

1. A camera lens assembly, comprising:
an optical lens group, comprising, sequentially along an optical axis from an object side to an image side: a first lens, a second lens, a third lens, a fourth lens, a fifth lens, and a sixth lens that have refractive powers, a refractive index of the third lens being greater than a refractive index of the second lens and a refractive index of the fourth lens, a refractive index of the fourth lens being less than a refractive index of the third lens and a refractive index of the fifth lens, and an object-side surface and an image-side surface of the fifth lens each having at least one inflection point;
a spacing element group, comprising a second spacing element, a third spacing element, and a fourth spacing element, wherein the second spacing element is disposed on an image-side surface of the second lens and is in contact with the image-side surface of the second lens, the third spacing element is disposed on an image-side surface of the third lens and is in contact with the image-side surface of the third lens, and the fourth spacing element is disposed on an image-side surface of the fourth lens and is in contact with the image-side surface of the fourth lens; and
a lens barrel, accommodating the optical lens group and the spacing element group;
wherein, an inner diameter d0m of an image-side end surface of the lens barrel and half of a maximal field-of-view Semi-FOV of the camera lens assembly satisfy: 4.2 mm<d0m/tan(Semi-FOV)<5.0 mm;
a spacing distance EP23 between the second spacing element and the third spacing element in a direction of the optical axis, an air gap T23 between the second lens and the third lens on the optical axis, and an air gap T34 between the third lens and the fourth lens on the optical axis satisfy: 0.9<EP23/(T23+T34)<1.8; and
a spacing distance EP34 between the third spacing element and the fourth spacing element in the direction of the optical axis, the air gap T34 between the third lens and the fourth lens on the optical axis, and an air gap T45 between the fourth lens and the fifth lens on the optical axis satisfy: 0.8<EP34/(T34+T45)<2.5.

2. The camera lens assembly according to claim 1, wherein, an outer diameter D0m of the image-side end surface of the lens barrel, an outer diameter D0s of an object-side end surface of the lens barrel, and half of the maximal field-of-view Semi-FOV of the camera lens assembly satisfy: 85.1°<(D0m/D0s)*Semi-FOV<90.6°.

3. The camera lens assembly according to claim 1, wherein, the spacing distance EP34 between the third spacing element and the fourth spacing element in the direction of the optical axis, a maximal thickness CP4 of the fourth spacing element, and a center thickness CT4 of the fourth lens satisfy: 0.7<(EP34+CP4)/CT4<1.2.

4. The camera lens assembly according to claim 1, wherein, an effective focal length f4 of the fourth lens, a distance SAG42 from an intersection point of the image-side surface of the fourth lens on the optical axis to a vertex of an effective radius of the image-side surface of the fourth lens on the optical axis, and the spacing distance EP34 between the third spacing element and the fourth spacing element in the direction of the optical axis satisfy: 1.8<f4/(|SAG42|+EP34)<3.2.

5. The camera lens assembly according to claim 1, wherein, a distance SAG31 from an intersection point of an object-side surface of the third lens on the optical axis to a vertex of an effective radius of the object-side surface of the third lens on the optical axis, a center thickness CT3 of the third lens, and the spacing distance EP23 between the second spacing element and the third spacing element in the direction of the optical axis satisfy: 0.9<(|SAG31|+CT3)/EP23<1.5.

6. The camera lens assembly according to claim 1, wherein, an inner diameter d3s of an object-side surface of the third spacing element, an inner diameter d2s of an object-side surface of the second spacing element, and a refractive index N3 of the third lens satisfy: 1.8<d3s/d2s*N3<2.2.

7. The camera lens assembly according to claim 1, wherein, an inner diameter d4s of an object-side surface of the fourth spacing element, an inner diameter d3s of an object-side surface of the third spacing element, and a refractive index N4 of the fourth lens satisfy: 1.7<d4s/d3s*N4<2.5.

8. The camera lens assembly according to claim 1, wherein, an effective focal length f1 of the first lens and an effective focal length f5 of the fifth lens satisfy: -
$$4.2 < f 1 / f 5 < - 2.1 ;$$
an effective focal length f3 of the third lens and an effective focal length f of the camera lens assembly satisfy: −5.8<f3/f<−2.2; and
an effective focal length f2 of the second lens and an effective focal length f4 of the fourth lens satisfy: 1.6<f2/f4<2.4.

9. The camera lens assembly according to claim 1, wherein, an inner diameter d0s of an object-side end surface of the lens barrel and an effective focal length f of the camera lens assembly satisfy: 0.9<d0s/f<1.3.

10. The camera lens assembly according to claim 1, wherein, an outer diameter D4s of an object-side surface of the fourth spacing element, an effective radius DT42 of the image-side surface of the fourth lens, and an inner diameter d4s of the object-side surface of the fourth spacing element satisfy: 0.9<(D4s-DT42)/d4s<1.7.

11. The camera lens assembly according to claim 1, wherein, an effective focal length f2 of the second lens, an effective focal length f3 of the third lens, an inner diameter d2s of an object-side surface of the second spacing element, and an inner diameter d3s of an object-side surface of the third spacing element satisfy:
$$2.8 < f 3 / f 2 / ( d 3 s / d 2 s ) < - 1.4 .$$

12. The camera lens assembly according to claim 1, wherein, the spacing element group further comprises a fifth spacing element disposed on the image-side surface of the fifth lens and at least partially in contact with the image-side surface of the fifth lens; and an outer diameter D4m of an image-side surface of the fourth spacing element, an outer diameter D5m of an image-side surface of the fifth spacing element, and a spacing distance EP45 between the fourth spacing element and the fifth spacing element in the direction of the optical axis satisfy:
$$18.4 < ( D 4 m + D 5 m ) / EP 45 < 26.2 .$$

13. The camera lens assembly according to claim 1, wherein, a radius of curvature R7 of an object-side surface of the fourth lens, a radius of curvature R8 of the image-side surface of the fourth lens, a radius of curvature R3 of an object-side surface of the second lens, and a radius of curvature R4 of the image-side surface of the second lens satisfy: −1.1<(R7+R8)/(R3−R4)<−0.5; and an outer diameter D4m of the image-side surface of the fourth spacing element and an outer diameter D2s of an object-side surface of the second spacing element satisfy: 1.0<D4m/D2s<1.9.

14. The camera lens assembly according to claim 1, wherein, the spacing element group further comprises a sixth spacing element disposed on an image-side surface of the sixth lens and at least partially in contact with an image-side surface of the sixth lens, an object-side surface of the sixth lens has at least one inflection point; and a distance YC52 from an inflection point nearest to the optical axis on an image-side surface of the fifth lens to the optical axis, a distance YC61 from an inflection point nearest to the optical axis on an object-side surface of the sixth lens to the optical axis, and a spacing distance EP46 between the fourth spacing element and the sixth spacing element in the direction of the optical axis satisfy:
$$1.4 < ( YC 52 + YC 61 ) / EP 46 < 2.2 .$$
